(19) United States
(12) Patent Application Publication
(10) Pub. No.: US 2024/0295039 A1
(43) Pub. Date: Sep. 5, 2024

(54) METHOD FOR MANUFACTURING AN ELECTROCATALYST, ELECTROCATALYST, ELECTRODE FOR AN ELECTROCHEMICAL CELL, ION EXCHANGE MEMBRANE, METHOD FOR MANUFACTURING AN ION EXCHANGE MEMBRANE, WATER ELECTROLYZER AND METHOD FOR MANUFACTURING A WATER ELECTROLYZER

(71) Applicant: Cutting-Edge Nanomaterials (CENmat) UG (haftungsbeschränkt), Pforzheim (DE)

(72) Inventors: Miriam Goll, Stuttgart (DE); Sambal Shashank Ambu, Stuttgart (DE)

(21) Appl. No.: 18/459,658

(22) Filed: Sep. 1, 2023

Related U.S. Application Data
(63) Continuation of application No. PCT/EP2022/055091, filed on Mar. 1, 2022.

(30) Foreign Application Priority Data
Mar. 1, 2021 (DE) 10 2021 104 784.6

(51) Int. Cl. C25B 11/077; C25B 1/04; C25B 9/23; C25B 11/032

(52) U.S. Cl. CPC C25B 11/077; C25B 1/04; C25B 9/23; C25B 11/032

(57) ABSTRACT

The invention relates to a method for manufacturing an electrocatalyst in the form of an HER catalyst for a water electrolyzer, wherein the HER catalyst is synthesised from an aqueous solution of a molybdenum salt with the addition of an aromatic amine and an acid.

The invention further relates to a method for manufacturing an electrocatalyst in the form of an OER catalyst for a water electrolyzer, electrocatalysts in the form of HER and OER catalysts, an electrode for electrochemical cells, an ion exchange membrane for an electrochemical reactor, a method for manufacturing an ion exchange membrane for an electrochemical reactor, a water electrolyzer, a method for manufacturing a catalytically active catalyst layer and a method for manufacturing a water electrolyzer.

### CROSS-REFERENCE TO RELATED APPLICATIONS

This application is a continuation of international application number PCT/EP2022/055091 filed on Mar. 1, 2022 and claims the benefit of German application number 10 2021 104 784.6 filed on Mar. 1, 2021, which are incorporated herein by reference in their entirety and for all purposes.

### FIELD OF THE INVENTION

The present invention relates to methods for manufacturing electrocatalysts generally, and more specifically to a method for manufacturing an electrocatalyst in the form of an HER catalyst for a water electrolyzer.

The present invention further relates to methods for manufacturing electrocatalysts generally, and more specifically to a method for manufacturing an electrocatalyst in the form of an OER catalyst for a water electrolyzer.

The present invention further relates to electrocatalysts generally, and more specifically to an electrocatalyst in the form of an HER catalyst for a water electrolyzer.

The present invention further relates to electrocatalysts generally, and more specifically to an electrocatalyst in the form of an OER catalyst for a water electrolyzer.

The invention further relates to electrodes for electrochemical cells generally, and more specifically to an electrode for an electrochemical cell, wherein a catalytically active catalyst layer which contains an electrocatalyst or is formed by an electrocatalyst is applied to the electrode.

The present invention further relates to exchange membranes for an electrochemical reactors generally, and more specifically to an ion exchange membrane for an electrochemical reactor, wherein the ion exchange membrane has a first membrane side and a second membrane side, wherein applied to the first and/or the second membrane side is a catalytically active catalyst layer which contains an electrocatalyst or is formed by an electrocatalyst.

The present invention further relates to methods for manufacturing ion exchange membranes generally, and more specifically to a method for manufacturing an ion exchange membrane for an electrochemical reactor, wherein the ion exchange membrane has a first membrane side and a second membrane side, wherein applied to the first and/or the second membrane side is a catalytically active catalyst layer which contains an electrocatalyst or is formed by an electrocatalyst.

The present invention further relates to water electrolyzers generally, and more specifically to a water electrolyzer having a first electrode, a second electrode and an ion exchange membrane arranged between the first electrode and the second electrode, wherein arranged between the first electrode and the ion exchange membrane is a first catalytically active catalyst layer which contains a first electrocatalyst or is formed by a first electrocatalyst and wherein arranged between the second electrode and the ion exchange membrane is a second catalytically active catalyst layer which contains a second electrocatalyst or is formed by a second electrocatalyst.

The present invention further relates to methods for manufacturing catalytically active catalyst layers generally, and more specifically to a method for manufacturing a catalytically active catalyst layer which contains an electrocatalyst or is formed by an electrocatalyst, for an electrochemical reactor, wherein the catalyst layer is applied to a substrate.

The present invention further relates to methods for manufacturing water electrolyzers generally, and more specifically to a method for manufacturing a water electrolyzer having a first electrode, a second electrode and an ion exchange membrane arranged between the first electrode and the second electrode, wherein arranged between the first electrode and the ion exchange membrane is a first catalytically active catalyst layer which contains a first electrocatalyst or is formed by a first electrocatalyst and wherein arranged between the second electrode and the ion exchange membrane is a second catalytically active catalyst layer which contains a second electrocatalyst or is formed by a second electrocatalyst.

### BACKGROUND OF THE INVENTION

The manufacture of hydrogen, which is usable in a broad range of fields such as, in particular, energy supply, chemical industries and transportation, is growing in importance. Hydrogen can be easily manufactured by the electrolysis of water. Water electrolyzers are utilised for the decomposition of water molecules. It is known, in particular, to configure water electrolyzers with ion exchange membranes which separate the two half cells of the water electrolyzer from one another. Ion exchange membranes are utilised, for example, in the form of anion exchange membranes. These are configured so that they enable a movement of anions from the cathodic half cell into the anodic half cell. For example, in an alkaline medium, OH⁻ ions migrate during operation of the water electrolyzer from the cathodic half cell into the anodic half cell and react there, while giving up electrons, to water and oxygen. In the cathodic half cell, water molecules are converted, while accepting electrons, to hydrogen and OH⁻ ions.

In order to enable the decomposition of water at the lowest possible cell voltages, catalysts are utilised. Noble metal catalysts such as, in particular, platinum and iridium have high efficiency and are usually stable in the long term. However, they are very costly and are not limitlessly available. In addition, known water electrolyzers comprising an anion exchange membrane that are operated with an alkaline electrolyte suffer from the problem that the electrodes and other components such as, for example, seals can become damaged by the electrolyte due to its agressiveness, during long-term operation. This has a negative effect on the long-term stability of these water electrolyzers.

It is therefore a problem to provide suitable electrocatalysts for the hydrogen evolution reaction, so-called HER catalysts, and suitable electrocatalysts for the oxygen evolution reaction, so-called OER catalysts which enable an optimal hydrogen evolution reaction and/or an optimal oxygen evolution reaction, but which are economical, available in large numbers and sustainable in manufacture. Furthermore, catalysts of this type should also as far as possible have high efficiency at low alkalinity together with a low cell voltage.

### SUMMARY OF THE INVENTION

In a first aspect of the invention, a method for manufacturing an electrocatalyst in the form of an HER catalyst for a water electrolyzer is provided. The HER catalyst is synthesised from an aqueous solution of a molybdenum salt with the addition of an aromatic amine and an acid.

In a second aspect of the invention, a method for manufacturing an electrocatalyst in the form of an OER catalyst for a water electrolyzer is provided. The OER catalyst is synthesised from an aqueous sodium borohydride solution by adding a mixture of an aqueous solution of a nickel salt and an aqueous solution of an iron salt.

In a third aspect of the invention, an electrocatalyst in the form of an HER catalyst for a water electrolyzer is provided. The HER catalyst contains at least one chemical compound which is formed of a first transition metal and at least one of the elements carbon, oxygen, sulfur and phosphorus. The first transition metal is molybdenum or tungsten.

In a fourth aspect of the invention, an electrocatalyst in the form of an OER catalyst for a water electrolyzer is provided. The OER catalyst contains nickel and iron in combination with oxygen and/or phosphorus. A nickel content of the nickel in the OER catalyst is greater than an iron content of the iron in the OER catalyst. A value of the sum of the nickel content and of the iron content is at least approximately 50 Mol % of a total metallic content of the OER catalyst.

In a fifth aspect of the invention, an electrode for an electrochemical cell is provided. Applied to the electrode is a catalytically active catalyst layer which contains an electrocatalyst or is formed by an electrocatalyst. The electrocatalyst is one of the electrocatalysts described above.

In a sixth aspect of the invention, an ion exchange membrane for an electrochemical reactor is provided. The ion exchange membrane has a first membrane side and a second membrane side. Applied to the first and/or the second membrane side is a catalytically active catalyst layer which contains an electrocatalyst or is formed by an electrocatalyst. The electrocatalyst is one of the advantageous electrocatalysts described above.

In a seventh aspect of the invention, a method for manufacturing an ion exchange membrane for an electrochemical reactor is provided. The ion exchange membrane has a first membrane side and a second membrane side. A catalytically active catalyst layer, which contains an electrocatalyst or is formed by an electrocatalyst, is applied to the first and/or the second membrane side. One of the advantageous electrocatalysts described above is used as the electrocatalyst.

In an eighth aspect of the invention, a water electrolyzer having a first electrode, a second electrode and an ion exchange membrane arranged between the first electrode and the second electrode is provided. Arranged between the first electrode and the ion exchange membrane is a first catalytically active catalyst layer which contains a first electrocatalyst or is formed by a first electrocatalyst. Arranged between the second electrode and the ion exchange membrane is a second catalytically active catalyst layer which contains a second electrocatalyst or is formed by a second electrocatalyst. The first electrocatalyst and/or the second electrocatalyst is one of the advantageous electrocatalysts described above.

In a ninth aspect of the invention, a method for manufacturing a catalytically active catalyst layer which contains an electrocatalyst or is formed by an electrocatalyst for an electrochemical reactor is provided. The catalyst layer is applied to a substrate. One of the advantageous electrocatalysts described above is used as the electrocatalyst.

In a tenth aspect of the invention, a method for manufacturing a water electrolyzer having a first electrode, a second electrode and an ion exchange membrane arranged between the first electrode and the second electrode is provided. Arranged between the first electrode and the ion exchange membrane is a first catalytically active catalyst layer which contains a first electrocatalyst or is formed by a first electrocatalyst. Arranged between the second electrode and the ion exchange membrane is a second catalytically active catalyst layer which contains a second electrocatalyst or is formed by a second electrocatalyst. The first catalyst layer is applied to the first electrode and/or the second catalyst layer is applied to the second electrode. The first electrode and the second electrode are pressed against the ion exchange membrane arranged between them.

### BRIEF DESCRIPTION OF THE DRAWING FIGURES

The foregoing summary and the following description may be better understood in conjunction with the drawing figures, of which:

FIG. 1 shows a schematic representation of the manufacture of an OER catalyst;

FIG. 2 shows a scanning electron micrograph of an exemplary embodiment of an OER catalyst;

FIG. 3 shows a schematic representation of an exemplary embodiment of a method for manufacturing an HER catalyst;

FIG. 4a shows a schematic representation of the application of a catalyst solution onto a substrate by spraying;

FIG. 4b shows a photographic reproduction of a catalyst layer prepared by spraying;

FIG. 5a shows a schematic representation of the application of a catalyst solution onto a substrate by means of screen printing;

FIG. 5b shows a photographic representation of an exemplary embodiment of a catalyst layer prepared by screen printing;

FIG. 6a shows a schematic representation of the forming of a catalyst layer on a substrate by film spreading and/or blade coating;

FIG. 6b shows a photographic reproduction of a catalyst layer formed by film spreading;

FIG. 7 shows a schematic exploded representation of an exemplary embodiment of an electrolysis cell;

FIG. 8 shows a schematic sectional view of an exemplary embodiment of an electrolyzer;

FIG. 9 shows a schematic exploded representation of a further exemplary embodiment of an electrolyzer;

FIG. 10 shows a comparative representation of operating parameters of different electrolysis cells;

FIG. 11 shows a comparative representation of cell parameters of further electrolysis cells;

FIG. 12 shows a scanning electron micrograph of an exemplary embodiment of an HER catalyst;

FIG. 13 shows a schematic representation of a construction of an exemplary embodiment of an alkaline water electrolyzer and its operating principle;

FIG. 14 shows reaction equations of the water electrolysis in an alkaline environment;

FIG. 15 shows a schematic representation of the construction of an exemplary embodiment of an ion exchange membrane coated on both sides with catalyst layers;

FIG. 16 shows a schematic representation of an exemplary embodiment of an ion exchange membrane before two substrates are pressed against it, each carrying a catalytically active layer on one side;

FIG. 17 shows the dependency of the current densities on the respective cathode potentials (relative to the reversible hydrogen electrode RHE) of the HER catalysts of the 2nd to 12th exemplary embodiments;

FIG. 18 shows the dependency of the current densities on the respective anode potentials (relative to the reversible hydrogen electrode RHE) of the OER catalysts of the 13th to 20th exemplary embodiments and of iridium black;

FIG. 19 shows the dependency of the cell potential on the current density for cell tests with an open cell with different membranes as stated;

FIG. 20 shows the dependency of the cell potential on the current density for cell tests with an open cell and a closed cell with different membranes; and

FIG. 21 shows results of long-term cell tests in the closed cell with NiFeOₓ/Mo₂C and Ir/Pt as the catalyst and the corresponding quantity of oxygen obtained (electrolyte: 0.1M KOH; cell temperature: 50° C.).

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a method for manufacturing an electrocatalyst in the form of an HER catalyst for a water electrolyzer, wherein the HER catalyst is synthesised from an aqueous solution of a molybdenum salt with the addition of an aromatic amine and an acid.

The proposed method of manufacture enables the forming, in a simple manner, of an HER catalyst which is or contains molybdenum carbide.

The HER catalyst can be synthesised in a simple manner if ammonium heptamolybdate is used as the molybdenum salt, if aniline is used as the aromatic amine and if hydrochloric acid is used as the acid. Thus, for example, the molybdenum salt can be dissolved in water and the aromatic amine can be added. In order to synthesise the HER catalyst, for example, the acid can then be added, in particular drop-wise. In place of aniline, another organic amine can also be used, for example, melamine.

In order to be able to synthesise the HER catalyst as pure as possible and in a good quality for the forming of catalyst layers, it is advantageous if the synthesised HER catalyst is washed and dried. For example, it can be washed with an alcohol, in particular ethanol, and then dried for a specified time, for example at temperatures in the range between 40° C. and 80° C.

Particularly good qualities of the HER catalyst can be achieved if the dried HER catalyst is baked. This can take place at temperatures in a range from approximately 600° C. to approximately 800° C. The baking preferably takes place under a protective gas in order to prevent undesirable oxidation of the catalyst in air

The invention further relates to a method for manufacturing an electrocatalyst in the form of an OER catalyst for a water electrolyzer, wherein the OER catalyst is synthesised from an aqueous sodium borohydride solution by adding a mixture of an aqueous solution of a nickel salt and an aqueous solution of an iron salt.

With the proposed method, it is possible in a simple manner, in particular, to synthesise OER catalysts which contain nickel and iron combined, in particular, with oxygen.

The method of manufacture can be simplified, in particular, if nickel(II) chloride is used as the nickel salt and if iron(II) chloride is used as the iron salt.

A particularly good reactivity and a highly efficient microscopic structure of the OER catalyst can be developed if ultrasound, heat and/or UV radiation is applied to the aqueous sodium borohydride solution when the mixture is added. In other words, energy is input to the sodium borohydride solution when the mixture is added.

In order to prevent oxidation of the aqueous sodium borohydride solution, it is favourable if a protective gas is applied to it when the mixture is added.

In order to be able to process the synthesised OER catalyst further, it is favourable if it is separated, washed and dried.

The invention further relates to an electrocatalyst in the form of an HER catalyst for a water electrolyzer, wherein the HER catalyst contains at least one chemical compound which is formed of a first transition metal and at least one of the elements carbon, oxygen, sulfur and phosphorus and wherein the first transition metal is molybdenum or tungsten.

An HER catalyst of this type has, in particular, an excellent hydrogen evolution activity. In addition, an oxidation, in particular, of such a catalyst in air results in no loss of activity.

It is favourable if the chemical compound is molybdenum carbide (MoCₓ), molybdenum oxide (MoOₓ) or molybdenum sulfide (MoSₓ). A catalytic activity of the compounds mentioned is very good, in particular also with a low alkalinity of an electrolyte in a water electrolyzer.

It is advantageous if the chemical compound contains at least one second transition metal if the first transition metal and the at least one second transition metal differ from one another, if the first transition metal defines a first metallic content of the chemical compound, if the at least one second transition metal defines a second metallic content and if the first metallic content is greater than the second metallic content. Such an electrocatalyst is effectively “doped” with a second transition metal. By the addition of the second transition metal, an effect of the catalyst can be further improved.

HER catalysts with a good effect can be provided, in particular, if the at least one second transition metal is molybdenum, tungsten, nickel, iron, cobalt, copper or titanium.

Favourably, the chemical compound is W_{2y}MO_{2(1-y)}C, Ni_{2y}MO_{2(1-y)}C or Fe_{y}Mo_{1-y}O₃. It is therein advantageous, in particular, if the value of y is not more than approximately 0.25. In other words, in this way, a molybdenum content is always significantly higher than a content of the second transition metal. Thus, the properties of the HER catalyst can be adjusted in a favourable manner by the content of the second transition metal.

It is advantageous if a total metallic content of the chemical compound is 100 Mol % and is defined as the sum of the first metallic content in Mol % and the second metallic content in Mol % and if the second metallic content has a value in a range from 0 to approximately 25 Mol %. In this way, it can be ensured that the first transition metal accounts for the majority of the metallic content in the chemical compound and so determines the significant properties of the HER catalyst.

Particularly efficient HER catalysts can be formed if a content of the chemical compound in the HER catalyst is in a range from approximately 67 percent by weight to approximately 85 percent by weight. In particular, it can be approximately 76 percent by weight.

For a good catalytic effect, it is advantageous if the HER catalyst contains molybdenum oxide. In particular, the content of molybdenum oxide can be in a range from approximately 5 percent by weight to approximately 13 percent by weight. In particular, it can be approximately 9 percent by weight.

Advantageously, the HER catalyst contains molybdenum, specifically in particular with a content in a range from approximately 10 percent by weight to approximately 20 percent by weight. In particular, the HER catalyst can contain approximately 15 percent by weight of molybdenum.

A particularly high efficiency of the electrocatalyst can be achieved if the HER catalyst has a needle-shaped or substantially needle-shaped structure. Thus, in particular, a large surface area of the HER catalyst can be realised and thereby a high catalytic activity.

Advantageously, the electrocatalyst is manufactured with one of the advantageous methods described above for manufacturing an electrocatalyst in the form of an HER catalyst for a water electrolyzer. In this way, in particular, HER catalysts can be formed which have a needle-shaped or substantially needle-shaped structure.

The invention further relates to an electrocatalyst in the form of an OER catalyst for a water electrolyzer, wherein the OER catalyst contains nickel and iron in combination with oxygen and/or phosphorus, wherein a nickel content of the nickel in the OER catalyst is greater than an iron content of the iron in the OER catalyst and wherein a value of the sum of the nickel content and of the iron content is at least approximately 50 Mol % of a total metallic content of the OER catalyst.

An electrocatalyst of this type has very good properties for supporting the oxygen evolution reaction in the anodic half cell of a water electrolyzer. The metallic main contents of the OER catalyst are nickel and iron. Optionally, further metals can be contained in the OER catalyst in order to optimise its efficiency.

It is also advantageous if the OER catalyst contains cobalt, copper and/or manganese, if the sum of a cobalt content, a copper content and a manganese content in the OER catalyst has a value that is smaller than the iron content. Since the iron content of the OER catalyst is smaller than the nickel content, the contents of cobalt, copper and/or manganese in the OER catalyst therefore have a proportionately small significance, but have positive effects on the properties of the OER catalyst.

It is advantageous if the sum of the cobalt content, the copper content and the manganese content in the total metallic content has a value in a range from 0 to approximately 20 Mol %. By suitable selection of the value, the properties of the OER catalyst can be optimised.

Furthermore it is favourable if the electrocatalyst is NiₓFe_{y}Cu_{z}O₄ or NiₓFe_{y}Mn_{z}O₄ und if x>y>z. The electrocatalysts mentioned have a good catalytic effect for the oxygen evolution reaction.

According to a further preferred embodiment, it can be provided that the OER catalyst contains nickel, iron and oxygen, that a content of nickel lies in a range from approximately 40 percent by weight to approximately 85 percent by weight, that a content of iron lies in a range from approximately 1 percent by weight to approximately 30 percent by weight and that a content of oxygen lies in a range from approximately 10 percent by weight to approximately 35 percent by weight. Such OER catalysts have a good catalytic effect for the oxygen evolution reaction.

It is further advantageous if the OER catalyst has a structure in the form of relatively large clusters that are covered with small nanoparticles. In this way, a large surface area can be realised, which helps to further improve an effect of the electrocatalyst.

Furthermore, it is favourable if the OER catalyst is manufactured by one of the advantageous methods for manufacturing an electrocatalyst as described above in the form of an OER catalyst for a water electrolyzer. In particular, by means of the methods of manufacture described, an OER catalyst with a structure having relatively large clusters that are covered with nanoparticles can be realised.

The invention further relates to an electrode for an electrochemical cell, wherein applied to the electrode is a catalytically active catalyst layer which contains an electrocatalyst or is formed by an electrocatalyst, wherein the electrocatalyst is one of the electrocatalysts described above.

Thus, electrodes for an electrochemical cell can be configured in a simple manner, for example in that an HER catalyst is applied to one electrode and an OER catalyst is applied to the other electrode and if the electrodes are brought with their catalyst layers into areal contact with an anion exchange membrane.

In order to be able to conduct away safely the reaction gases formed, it is advantageous if the electrode comprises a gas diffusion layer and if the catalyst layer is applied on the gas diffusion layer.

It is favourable if the electrode is configured in the form of an anode and if the electrocatalyst is an OER catalyst. In particular, this can be one of the advantageous OER catalysts described above. An anodic half cell of a water electrolyzer can be configured in this manner.

It is advantageous if the electrode is configured in the form of a cathode and if the electrocatalyst is an HER catalyst. In particular, the HER catalyst can be one of the advantageous HER catalysts described above. A cathodic half cell of a water electrolyzer with high efficiency can thus be formed.

The invention further relates to an ion exchange membrane for an electrochemical reactor, wherein the ion exchange membrane has a first membrane side and a second membrane side, wherein applied to the first and/or the second membrane side is a catalytically active catalyst layer which contains an electrocatalyst or is formed by an electrocatalyst, wherein the electrocatalyst is one of the advantageous electrocatalysts described above.

Thus, ion exchange membranes can be configured, in particular, as independent units with the electrocatalysts described above, which simplifies the manufacture of water electrolyzers. The ion exchange membrane can be coated, for example, one-sidedly or two-sidedly with a catalyst layer, optionally an HER catalyst and/or an OER catalyst.

To form a water electrolyzer which is to be operated in an alkaline environment, it is advantageous if the ion exchange membrane is configured in the form of an anion exchange membrane. This makes it possible, in particular, that OH ions from the cathodic half cell can pass into the anodic half cell of a water electrolyzer.

It is favourable, if a first catalyst layer is applied to the first membrane side, if the first catalyst layer contains a first electrocatalyst or is formed by a first electrocatalyst and if the first electrocatalyst is an OER catalyst. In particular, the OER catalyst can be one of the advantageous OER catalysts described above.

Thus, an ion exchange membrane can be coated in a simple manner with economical but nevertheless highly active OER catalysts.

It is advantageous if a second catalyst layer is applied to the second membrane side, if the second catalyst layer contains a second electrocatalyst or is formed by a second electrocatalyst and if the second electrocatalyst is an HER catalyst. In particular, the HER catalyst can be one of the advantageous HER catalysts described above. The ion exchange membrane can thus serve in a simple manner to delimit a cathodic half cell of a water electrolyzer.

The invention further relates to a method for manufacturing an ion exchange membrane for an electrochemical reactor, wherein the ion exchange membrane has a first membrane side and a second membrane side, wherein a catalytically active catalyst layer, which contains an electrocatalyst or is formed by an electrocatalyst, is applied to the first and/or the second membrane side, wherein one of the advantageous electrocatalysts described above is used as the electrocatalyst.

Thus, an ion exchange membrane can be configured in a simple manner as an independent unit which can be used to form a water electrolyzer.

It is favourable if, in order to apply the first catalyst layer to the first membrane side and the second catalyst layer to the second membrane side, the first catalyst layer applied to a first transfer carrier is brought into areal contact with the first membrane side and the second catalyst layer applied to a second transfer carrier is brought into areal contact with the second membrane side and they are pressed against one another. The catalyst layers are therefore not applied directly onto the ion exchange membrane, but rather initially each onto a transfer carrier. From the transfer carrier which can be configured in the form of a transfer substrate, the catalyst layers are then transferred in that they are laid, with the respective catalyst layer, areally against one of the membrane sides and are then pressed against the ion exchange membrane. In a further step, the transfer carrier can then be removed, for example, pulled off.

In order to achieve a good connection of the catalyst layers and the ion exchange membrane, it is advantageous if the catalyst layers and the ion exchange membrane are heated during the pressing. In particular, they can be heated to a temperature in a range from approximately 40° C. to approximately 130° C. In particular, the temperature during pressing can be approximately 65° C.

In order to achieve a good connection of the catalyst layers with the ion exchange membrane, it is favourable if the pressing is carried out at a pressure in a range from approximately 5 bar to approximately 130 bar.

A good connection of the catalyst layers with the ion exchange membrane can be achieved, in particular, in that the pressing is carried out over a time period from approximately 1 min to approximately 15 min. In particular, the time period can be approximately 4 min.

Preferably, the transfer carriers are pulled off the catalyst layers after the pressing. If the ion exchange membranes that are provided with catalyst layers are used as independent units, the transfer carriers can also remain initially. They can thus be used as a protective layer. For the manufacture of a water electrolyzer, the transfer carriers are then pulled off before the catalyst layers are brought into contact with an electrode of the water electrolyzer.

The invention further relates to a water electrolyzer having a first electrode, a second electrode and an ion exchange membrane arranged between the first electrode and the second electrode, wherein arranged between the first electrode and the ion exchange membrane is a first catalytically active catalyst layer which contains a first electrocatalyst or is formed by a first electrocatalyst and wherein arranged between the second electrode and the ion exchange membrane is a second catalytically active catalyst layer which contains a second electrocatalyst or is formed by a second electrocatalyst, wherein the first electrocatalyst and/or the second electrocatalyst is one of the advantageous electrocatalysts described above.

The proposed development of known water electrolyzers thus enables, in particular, the provision of an HER catalyst in the form of molybdenum carbide and of an OER catalyst in the form of nickel iron oxide.

It is favourable if the first electrode and/or the second electrode is configured in the form of one of the advantageous electrodes described above. In this way, a manufacture of the water electrolyzer can be simplified, in particular if the electrodes are inserted already coated.

It is advantageous if the first electrode is configured in the form of an anode, if the second electrode is configured in the form of a cathode and if the ion exchange membrane is configured in the form of an anion exchange membrane. In this way, an anion exchange membrane water electrolyzer can be configured in a simple manner.

Favourably, the first electrocatalyst is an OER catalyst and the second electrocatalyst is an HER catalyst. In particular, the OER catalyst is one of the OER catalysts described above. Furthermore, the HER catalyst is one of the advantageous HER catalysts described above. Thus, a water electrolyzer with a high efficiency level can be formed simply and economically.

For the manufacture of the water electrolyzer, it is advantageous if the first catalyst layer is applied to the first electrode or to the ion exchange membrane and if the second catalyst layer is applied to the second electrode or to the ion exchange membrane. Thus, in particular, subunits, optionally the ion exchange membrane or the electrodes, can be formed which already carry the respective catalyst layers.

A water electrolyzer can be formed in a particularly simple manner if the first electrode with the first catalyst layer, the ion exchange membrane and the second electrode with the second catalyst layer are pressed against each other. With this configuration, therefore, electrodes already coated with electrocatalysts are utilised, which are then pressed against an uncoated ion exchange membrane. This is advantageous, in particular, if the ion exchange membrane is configured in the form of an anion exchange membrane. Anion exchange membranes are typically not very stable mechanically. It is therefore technically extremely difficult to apply the catalyst layers onto these membranes. The procedure described significantly simplifies the manufacture of water electrolyzers.

It is advantageous if the water electrolyzer comprises an electrolyte having a pH value in the range from approximately 7 to approximately 13. Preferably, the pH value of the electrolyte is in the range from approximately 7 to approximately 11. In particular, an electrolyte with a pH value close to 7 can be utilised, that is, an electrolyte that is only weakly alkaline. In this way, in particular, a long-term stability of the water electrolyzer can be enhanced since strongly alkaline electrolytes are highly aggressive and thus the danger exists that components of the water electrolyzer, for example, electrodes and seals, coming into contact with the electrolyte could be damaged.

The water electrolyzer can be configured in a simple manner if the electrolyte is formed by a neutral to alkaline salt dissolved in a solvent.

It is favourable if the neutral to alkaline salt has a concentration with a value in a range from 0 to approximately 0.4 molar, in particular, it can be in a range from 0 to 0.1 molar. Thus, in particular, weakly alkaline electrolytes can be formed.

It is advantageous if the neutral to alkaline salt is or contains potassium hydroxide (KOH), sodium hydroxide (NaOH), lithium hydroxide (LiOH), sodium or potassium carbonate or sodium or potassium hydrogencarbonate (Na₂CO₃, K₂CO₃, NaHCO₃, KHCO₃).

Preferably, the solvent is or contains water or alcohol. Thereby, in particular, environmentally friendly water electrolyzers can be formed.

The invention further relates to a method for manufacturing a catalytically active catalyst layer which contains an electrocatalyst or is formed by an electrocatalyst for an electrochemical reactor, wherein the catalyst layer is applied to a substrate, wherein one of the advantageous electrocatalysts described above is used as the electrocatalyst.

By means of the use of the electrocatalysts mentioned, catalytically highly effective catalyst layers can be formed.

Preferably, an electrode, a gas diffusion layer arranged on an electrode or an ion exchange membrane of the electrochemical reactor or a transfer carrier is used as the substrate. Dependent upon which catalyst layer and which type of electrochemical cell is involved, the catalyst layers can optionally be formed on the electrode, the gas diffusion layer, the ion exchange membrane or a transfer carrier.

Catalyst layers can be configured in a simple manner on substrates in the form of a carbon fibre mat, a metal fibre mat or a stainless steel wire weave stack. In particular, the metal fibre mats can be configured in the form of titanium fibre mats, nickel fibre mats or stainless steel fibre mats.

For handling during the manufacture of electrochemical reactors, it is favourable if the catalyst layer applied to the transfer carrier is applied to the electrode, the gas diffusion layer arranged on an electrode or the ion exchange membrane of the electrochemical reactor is applied and the transfer carrier is pulled off. The application of the catalyst layer can be optimised, in particular, if the substrate and the transfer carrier are pressed against one another, in particular at a temperature that is above room temperature. In other words, heating of the transfer carrier and the substrate during transference of the catalyst layer is advantageous.

Catalyst layers can be handled in a simple manner if a film is used as the transfer carrier. In particular, it can be made of plastics or metal. The plastics can be, for example, polytetrafluoroethylene. A plastics film of this type can be pulled off the catalyst layer in a simple manner if it has been applied, for example, onto an ion exchange membrane or an electrode.

The catalyst layer can be formed in a simple manner if it is formed by applying a catalyst solution which contains the electrocatalyst onto the substrate. Catalyst solutions can be handled in a simple manner and applied to the substrate by different methods.

In order to optimise an adhesion of the catalyst to form the catalyst layer on the substrate, it is favourable if the substrate is heated during application of the catalyst solution. In particular, it can be heated to a temperature in the range from approximately 50° C. to approximately 90° C. In particular, the temperature can be approximately 65° C.

The catalyst layer can be configured in a simple manner in that the catalyst solution is applied by spraying, screen printing, film spreading or blade coating onto the substrate.

Particularly efficient catalyst layers can be formed if the catalyst solution is applied by spraying on a plurality of layers with a spray pistol from a distance of approximately 3 cm to approximately 10 cm by means of an inert gas stream with a volume flow in a range from approximately 1 l/min to approximately 5 l/min. The distance of the spray pistol from the substrate during the spraying on can be approximately 5 cm. The volume flow of the inert gas can be formed, in particular, by a nitrogen and/or argon stream. A volume stream of the inert gas can be, in particular 2 l/min.

For the handling of the catalyst layers, it is favourable if the catalyst solution applied onto the substrate is dried. Thus, in particular, long-term stable catalyst layers can be formed in a simple manner.

Preferably, the catalyst solution can be formed by dissolving the electrocatalyst in a solvent. It is particularly environmentally friendly if the solvent is water and/or alcohol.

Favourably, propanol is used as the alcohol. It can be, in particular, 2-propanol.

In order to achieve a good adhesion of the catalyst layer, in particular, on an ion exchange membrane, it is advantageous if an ion exchange ionomer is added to the solution of the electrocatalyst in the solvent. Preferably, it is an ionomer from which the ion exchange membrane is made.

Dependent upon the ion exchange membrane used, it is advantageous if Nafion, Aquivion, Sustainion XB-7 and/or Fumion is used as the ion exchange ionomer.

In order to form as homogeneous a catalyst solution as possible and thereby homogeneous catalyst layers on the substrate, it is advantageous if the catalyst layer is mixed before the application onto the substrate under the action of ultrasound. A mixing time can be in a range, in particular, from approximately 5 min to approximately 25 min. In particular, it can be approximately 15 min.

The invention further relates to a method for manufacturing a water electrolyzer having a first electrode, a second electrode and an ion exchange membrane arranged between the first electrode and the second electrode, wherein arranged between the first electrode and the ion exchange membrane is a first catalytically active catalyst layer which contains a first electrocatalyst or is formed by a first electrocatalyst and wherein arranged between the second electrode and the ion exchange membrane is a second catalytically active catalyst layer which contains a second electrocatalyst or is formed by a second electrocatalyst, wherein the first catalyst layer is applied to the first electrode and/or the second catalyst layer is applied to the second electrode and wherein the first electrode and the second electrode are pressed against the ion exchange membrane arranged between them.

In particular, with mechanically unstable ion exchange membranes, water electrolyzers can thereby be formed in a simple manner. The contact between the ion exchange membrane and the first catalyst layer can thus be created in a simple manner. In particular, the second catalyst layer can also be applied to the second electrode before the electrodes are pressed against the ion exchange membrane arranged between them.

Preferably, one of the advantageous electrocatalysts described above is used as the first electrocatalyst and/or as the second electrocatalyst. Thus, in particular, the first electrocatalyst can be one of the HER catalysts described above and the second electrocatalyst can be one of the OER catalysts described above.

The water electrolyzer can be formed in a simple manner if electrodes described above as advantageous exemplary embodiments are used as the first electrode and the second electrode.

Furthermore, the water electrolyzer can be formed in a simple manner, in particular in that the first catalyst layer and/or the second catalyst layer is formed by means of one of the advantageous methods described above.

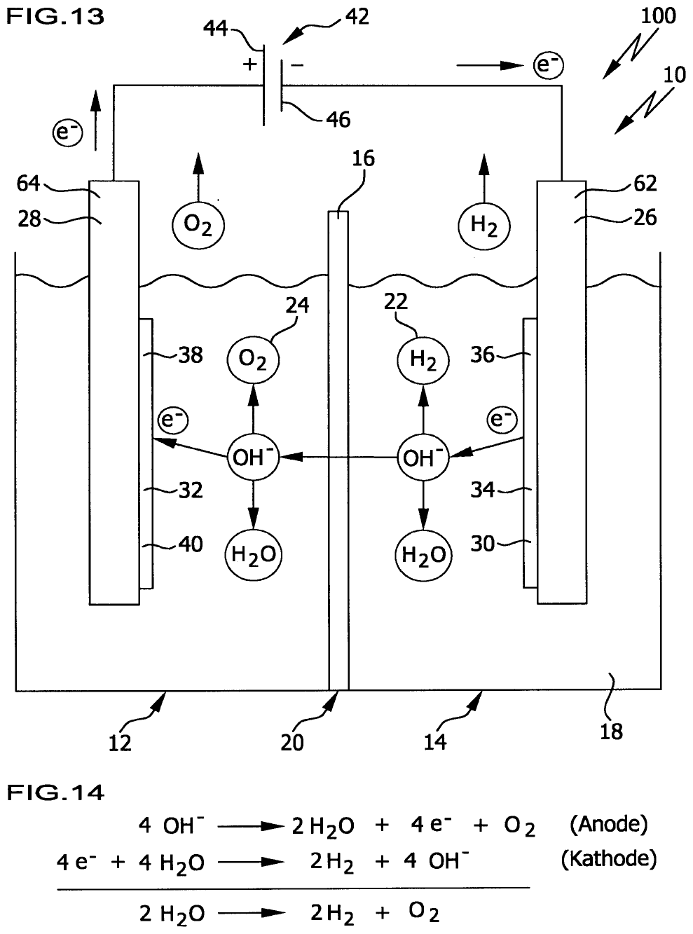

Firstly, for an introduction to and comprehension of the invention, the construction of a water electrolyzer will be described, making reference to FIG. 13.

FIG. 13 shows schematically an exemplary embodiment of a water electrolyzer 10 having an anodic half cell 12 and a cathodic half cell 14. The two half cells 12 and 14 are separated from one another by an ion exchange membrane 16.

The exemplary embodiment shown of the water electrolyzer 10 is a so-called alkaline water electrolyzer 10 which is operated with an alkaline electrolyte 18. The electrolyte 18 therefore has a pH value greater than 7.

The ion exchange membrane 16 is configured in the alkaline water electrolyzer 10 in the form of an anion exchange membrane 20 which enables anions 22 in the form of hydroxide ions 24 to pass from one of the two half cells 12 and/or 14 into the other half cell 12 and/or 14.

In the cathodic half cell 14, a cathode 26 is immersed into the electrolyte 18 and in the anodic half cell 12, an anode 28. The cathode 26 is at least partially covered with a cathodic catalyst layer 30, while the anode 28 is partially covered with an anodic catalyst layer 32.

The cathodic catalyst layer 30 consists of or contains an electrocatalyst 34 in the form of an HER catalyst 36 which supports the hydrogen evolution reaction (HER), that is, the conversion of water into hydrogen and hydroxide ions with the uptake of electrons. The anodic catalyst layer 30 is formed by an electrocatalyst 38 in the form of an OER catalyst 40, which supports the oxygen evolution reaction (OER) in the anodic half cell 12, and therefore the conversion of hydroxide ions into oxygen and water with the donation of electrons. The water electrolyzer 10 is powered by a current source 42 the positive pole 44 of which is connected to the anode 28 and the negative pole 46 of which is connected to the cathode 26.

The reactions of the alkaline water electrolysis taking place in the two half cells 12 and 14 are summarised in FIG. 14.

In order to operate the water electrolyzer 10, a minimum cell voltage is required in order to enable, firstly, the oxygen evolution reaction in the anodic half cell 12 and, secondly, the hydrogen evolution reaction in the cathodic half cell 14 to take place at all.

As previously mentioned, electrocatalysts 34 and 38 in the form of HER catalysts 36 and OER catalysts 40 are used in order to be able to operate the water electrolyzer 10 with the lowest possible cell voltage. As the electrocatalyst both for the oxygen evolution reaction and also for the hydrogen evolution reaction, in principle, platinum and iridium can be used. However, these noble metals are very costly so that there is a great interest in using catalysts that are more economical but have a similar efficiency to platinum and iridium. Exemplary embodiments of different electrocatalysts 34 and 38 which can replace platinum and iridium in alkaline water electrolyzers 10 will now be described.

### 1st Exemplary Embodiment HER Catalyst—Manufacture

Ammonium heptamolybdate hexahydrate (49.6 g) was dissolved in water (18.2 M Ω, 800 ml) and aniline (64 g) was added. Hydrochloric acid (1 M) was added dropwise to this emulsion until, at a pH value of approximately 4, a white precipitate was obtained (560 ml). The reaction solution was stirred for 5 h at 50° C. The precipitate was then separated, washed with ethanol and dried for 12 h at 50° C. The final weight was 59 g.
41 g of the raw product obtained was tempered in a quartz tube, whereby air was initially excluded from the reaction chamber with an argon stream (0.4 l/min) for 4 h. The raw product was heated to 300° C. at a rate of 2° C./min in the argon stream and then held at this temperature for 5 h and subsequently allowed to cool. For passivation of the pyrophoric MO₂C, the product was flushed for 1 h with humid argon, then flushed for 2 h with approximately 10% oxygen in nitrogen and subsequently flushed for 0.5 h with synthetic air before being exposed to air. Final weight: 24.3 g.

### 2nd Exemplary Embodiment HER Catalyst—Manufacture (AB2)

Ammonium heptamolybdate hexahydrate (33.03 g) was dissolved in water (18.2 M(2, 533 ml) and aniline (42.7 g) was added. Hydrochloric acid (1 M) was added dropwise to this emulsion until, at a pH value of approximately 4, a white precipitate was obtained (350 ml). The reaction solution was stirred for 5 h at 50° C. The precipitate was then separated, washed with ethanol and dried for 12 h at 50° C. The final weight was 36.4 g.
The raw product was heated to 725° C. at a rate of 2° C./min in the argon stream and then held at this temperature for 5 h and subsequently allowed to cool. For passivation of the pyrophoric Mo₂C, the product was flushed for 2 h with 2% oxygen in nitrogen before being exposed to air. The final weight was 11.4 g.

### 3rd Exemplary Embodiment HER Catalyst—Manufacture (AB3)

The manufacture took place according to the 2nd exemplary embodiment, although the raw product was heated in a quartz tube to only 600° C. in an argon stream.

### 4th Exemplary Embodiment HER Catalyst—Manufacture (AB4)

The manufacture took place according to the 2nd exemplary embodiment, although the raw product was heated in a quartz tube to 900° C. in an argon stream.

### 5th Exemplary Embodiment HER Catalyst—Manufacture (AB5)

Ammonium heptamolybdate hexahydrate (2.48 g) was dissolved in water (18.2 M(2, 40 ml) and aniline (3.14 g) was added. Hydrochloric acid (1 M) was added dropwise to this emulsion until, at a pH value of approximately 4, a white precipitate was obtained (30 ml). The reaction solution was stirred for 5 h at 50° C. The precipitate was then separated and washed with ethanol. The wet precipitate was suspended with ethanol solutions of nickel chloride hexahydrate (0.33 g in 100 ml) and the ethanol was evaporated in a glass dish while stirring at 50° C. The final weight was 2.7 g.
1.4 g of the raw product obtained was tempered in a quartz tube, whereby air was initially excluded from the reaction chamber with an argon stream (0.4 l/min) for 4 h. The raw product was heated to 600° C. at a rate of 2° C./min in the argon stream and then held at this temperature for 5 h and subsequently allowed to cool. The final weight was 0.67 g. In order to remove excess nickel, the product was washed with a 0.1 M HCl solution and then washed with ethanol and dried. The final weight was 0.61 g.

### 6th Exemplary Embodiment HER Catalyst—Manufacture (AB6)

Ammonium heptamolybdate hexahydrate (2.48 g) was dissolved in water (18.2 M(2, 40 ml) and aniline (3.14 g) was added. Hydrochloric acid (1 M) was added dropwise to this emulsion until, at a pH value of approximately 4, a white precipitate was obtained (30 ml). The reaction solution was stirred for 5 h at 50° C. The precipitate was then separated and washed with ethanol. The wet precipitate was suspended with ethanol solutions of iron(III) chloride tetrahydrate (0.23 g in 100 ml) and the ethanol was evaporated in a glass dish while stirring at 50° C. The final weight was 2.75 g.
1.4 g of the raw product obtained was tempered in a quartz tube, whereby air was initially excluded from the reaction chamber with an argon stream (0.4 l/min) for 4 h. The raw product was heated to 900° C. at a rate of 2° C./min in the argon stream and then held at this temperature for 5 h and subsequently allowed to cool. The final weight was 0.7 g. In order to remove excess iron, the product was washed with a 0.1 M HCl solution and then washed with ethanol and dried. The final weight was 0.62 g.

### 7th Exemplary Embodiment HER Catalyst—Manufacture (AB7)

The manufacture took place according to the 2nd exemplary embodiment.
500 mg of the product was suspended with an ethanol solution of nickel chloride hexahydrate (0.05 g in 2 ml) and the ethanol was allowed to evaporate. The raw product was tempered in a quartz tube, whereby air was initially excluded from the reaction chamber in an argon stream (0.4 l/min) for 4 h. The raw product was heated to 700° C. at a rate of 2° C./min in the argon stream and then held at this temperature for 5 h and subsequently allowed to cool. The final weight was 0.25 g.
In order to remove excess nickel, the product was washed with a 0.1 M HCl solution and then washed with ethanol and dried. The final weight was 0.24 g.

### 8th Exemplary Embodiment HER Catalyst—Manufacture (AB8)

The manufacture took place according to the 2nd exemplary embodiment.
500 mg of the product was suspended with an ethanol solution of iron(III)chloride tetrahydrate (0.04 g in 2 ml) and the ethanol was allowed to evaporate. The raw product was tempered in a quartz tube, whereby air was initially excluded from the reaction chamber with an argon stream (0.4 l/min) for 4 h. The raw product was heated to 500° C. at a rate of 2° C./min in the argon stream and then held at this temperature for 5 h and subsequently allowed to cool. The final weight was 0.27 g.
In order to remove excess iron, the product was washed with a 0.1 M HCl solution and then washed with ethanol and dried. The final weight was 0.26 g.

### 9th Exemplary Embodiment HER Catalyst—Manufacture (AB9)

The manufacture took place according to the 2nd exemplary embodiment, wherein during the synthesis of the precursor 15% of the molybdenum (Mo) was replaced by nickel (Ni).
Ammonium heptamolybdate hexahydrate (2.1 g) and nickel chloride hexahydrate (0.5 g) were dissolved in water (18.2 M Ω, 40 ml) and aniline (3.2 g) was added. Hydrochloric acid (1 M) was added dropwise to this emulsion until, at a pH value of approximately 4, a white precipitate was obtained (30 ml). The reaction solution was stirred for 5 h at 50° C. The precipitate was then separated, washed with ethanol and dried for 12 h at 50° C. The final weight was 2.36 g.
1 g of the raw product obtained was tempered in a quartz tube, whereby air was initially excluded from the reaction chamber with an argon stream (0.4 l/min) for 4 h. The raw product was heated to 1200° C. at a rate of 2° C./min in the argon stream and then held at this temperature for 5 h and subsequently allowed to cool. The final weight was 0.48 g.

### 10th Exemplary Embodiment HER Catalyst—Manufacture (AB10)

In this exemplary embodiment, a different organic amine was used in place of aniline in the synthesis.
Melamine (2.52 g) was dissolved in water (18.2 MΩ, 60 ml) and heated to 75° C. Ammonium heptamolybdate hexahydrate (2.48 g) was dissolved in water (18.2 MOhm, 10 ml) and added to the above solution, whereupon a fine white precipitate formed. Thereupon 1 M aqueous HCl solution was added until a pH value of 4 was achieved (approximately 15 ml). The reaction solution was stirred for 5 h at 75° C. The precipitate was then separated, washed with ethanol and dried for 12 h at 60° C. The final weight was 3.48 g.
3.1 g of the raw product obtained was ground in a mortar and tempered in a quartz tube, whereby air was initially excluded from the reaction chamber with a nitrogen stream (2 l/min) for 4 h. The raw product was heated to 900° C. at a rate of 10° C./min in the nitrogen stream and then held at this temperature for 2 h and subsequently allowed to cool. The final weight was 1.14 g.

### 11th Exemplary Embodiment HER Catalyst—Manufacture (AB11)

In this exemplary embodiment, a different organic amine was used in place of aniline in the synthesis.
Ammonium heptamolybdate hexahydrate (2.48 g) and oxalic acid dihydrate (5.04 g) were dissolved in water (18.2 MOhm, 70 ml) and heated to 75° C. Melamine (2.52 g) was added thereto. The reaction solution was stirred for 5 h at 75° C. The precipitate was then separated, washed with water and ethanol and dried for 12 h at 60° C. The final weight was 4.81 g.
2.8 g of the raw product obtained was ground in a mortar and tempered in a quartz tube, whereby air was initially excluded from the reaction chamber with a nitrogen stream (2 l/min) for 4 h. The raw product was heated to 900° C. at a rate of 10° C./min in the nitrogen stream and then held at this temperature for 2 h and subsequently allowed to cool. The final weight was 0.64 g.

### 12th Exemplary Embodiment HER Catalyst—Manufacture (AB12)

Oxalic acid dihydrate (25.2 g) was dissolved in water (18.2 MOhm, 400 ml) and ammonium heptamolybdate hexahydrate (2.7 g) and melamine (12.6 g) were added, and heated to 60° C. while stirring for 6 h. Thereafter nickel chloride hexahydrate (24 g dissolved in water (18.2 MOhm, 100 ml)) was added and stirred for 16 h at room temperature (RT). The precipitate was separated, washed with water and dried for 12 h at 70° C. The final weight was 38 g.
37 g of the raw product obtained was ground in a mortar and tempered in a quartz tube, whereby air was initially excluded from the reaction chamber with a nitrogen stream (2 l/min) for 4 h. The raw product was heated to 900° C. at a rate of 10° C./min in the nitrogen stream and then held at this temperature for 2 h and subsequently allowed to cool. The final weight was 8.35 g.

The catalytic effect of the second exemplary embodiment of an HER catalyst as described is better in comparison with the first exemplary embodiment of the HER catalyst. Significant components of the two exemplary embodiments of HER catalysts described are molybdenum carbide.

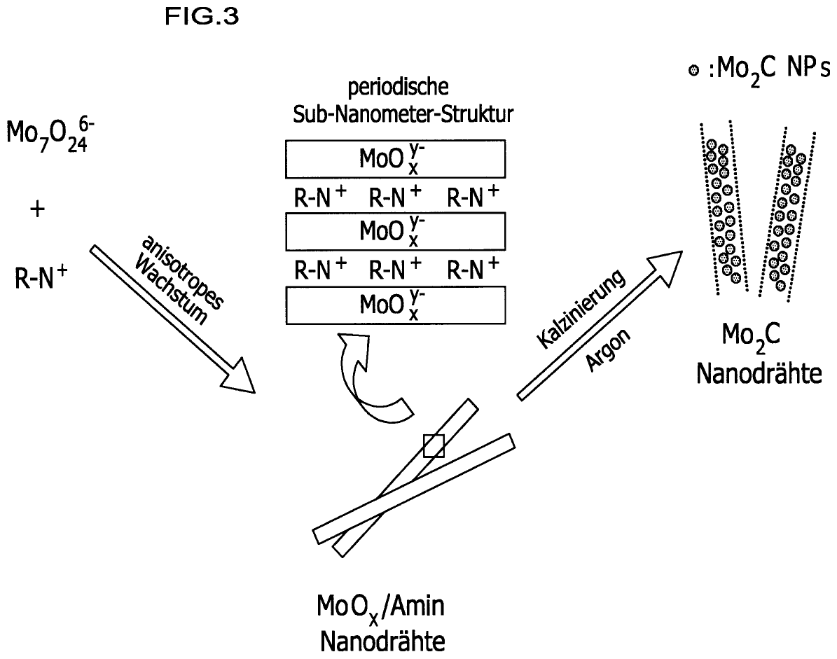

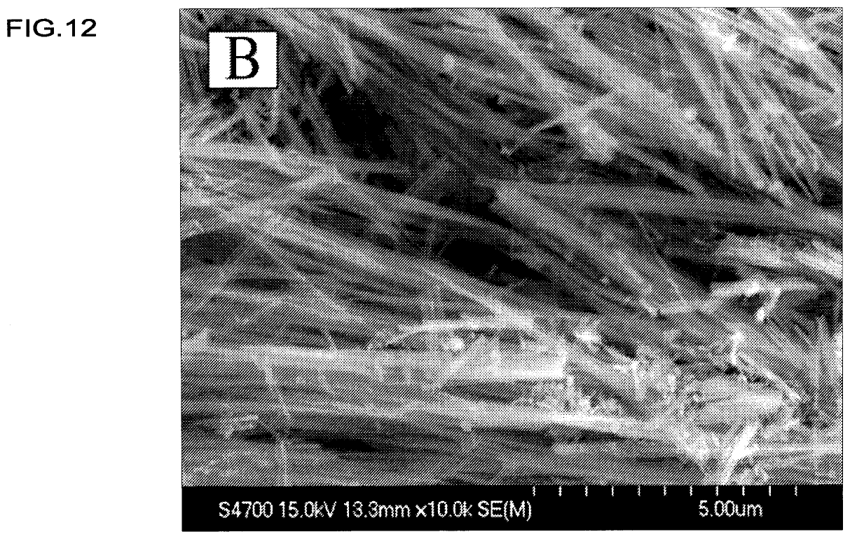

FIG. 3 shows schematically the sequence of the syntheses described of the two exemplary embodiments of the HER catalysts 36 in the form of molybdenum carbide (Mo₂C). A peculiarity of the synthesis described is the needle-shaped or tubule-shaped structure of the material as is clearly apparent, in particular, in FIG. 12, a scanning electron micrograph of an exemplary embodiment of molybdenum carbide.

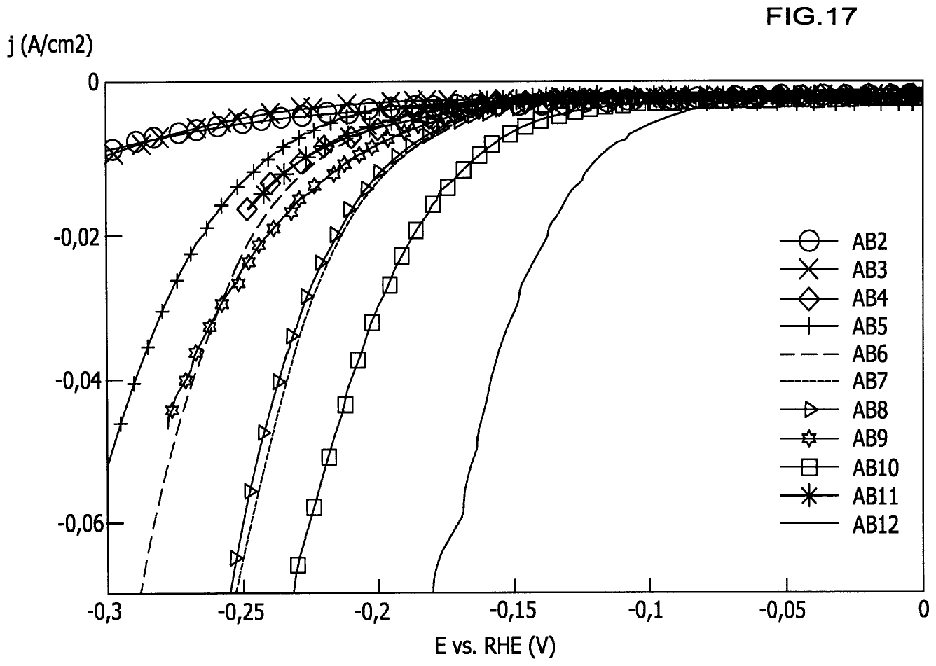

FIG. 17 shows the dependency of the current densities on the respective cathode potentials (relative to the reversible hydrogen electrode RHE) of the HER catalysts of the 2nd to 12th exemplary embodiments. The measurements were each made by means of a rotating disk electrode. The greatest current density at the lowest potential was achieved for the HER catalyst according to the 2nd exemplary embodiment.

Hereinafter, exemplary embodiments of electrocatalysts 38 in the form of OER catalysts 40 are described.

### 13th Exemplary Embodiment OER Catalyst—Manufacture (AB13)

Nickel(II) chloride hexahydrate (303 mg) was dissolved in water (18.2 M Ω, 50 ml) and similarly iron(II) chloride tetrahydrate (89 mg) was dissolved in water (18.2 M Ω, 50 ml). The two solutions were mixed.
A reaction flask was placed under nitrogen and sodium borohydride (326 mg) was dissolved in water (18.2 M Ω, 200 ml) therein. The nickel/iron solution was added dropwise to this solution within 4 minutes. Thereafter, the reaction solution was stirred for 30 minutes. The reaction product was then separated, washed with water and ethanol and dried for 12 h at 50° C. The final weight was 116 mg.

### 14th Exemplary Embodiment OER Catalyst—Manufacture (AB14)

Nickel(II) chloride hexahydrate (9.745 mg) was dissolved in water (18.2 M Ω, 133 ml), and similarly iron(II) chloride tetrahydrate (2.823 mg) was dissolved in water (18.2 M Ω, 133 ml). The two solutions were mixed.
A reaction flask was placed under nitrogen, and sodium borohydride (10.44 mg) was dissolved in water (18.2 M Ω, 533 ml) therein. This solution was subjected to ultrasound (160 W, 35 kHz) and the nickel/iron solution was added dropwise within 10 minutes. Thereafter, the reaction solution was stirred for 30 minutes. The reaction product was then separated, washed with water and ethanol and dried for 12 h at 50° C. The final weight was 5.45 g.

### 15th Exemplary Embodiment OER Catalyst—Manufacture (AB15)

The manufacture took place according to the 13th exemplary embodiment, wherein during the synthesis, 10% of the Ni was replaced by copper (Cu).
Nickel(II) chloride hexahydrate (8.528 g) and iron(II) chloride tetrahydrate (2.744 g) were dissolved in water (18.2 MΩ, 89 ml each). Similarly, copper(II) chloride dihydrate (0.940 g) was dissolved in water (18.2 M Ω, 89 ml). The two solutions were mixed.
A reaction flask was placed under nitrogen, and sodium borohydride (10.44 mg) was dissolved in water (18.2 M Ω, 533 ml) therein. The nickel/iron/copper solution was added dropwise within 10 minutes. Thereafter, the reaction solution was stirred for 30 minutes. The reaction product was then separated, washed with water and ethanol and dried for 12 h at 50° C. The final weight was 5.31 g.

### 16th Exemplary Embodiment OER Catalyst—Manufacture (AB16)

The manufacture took place according to the 13th exemplary embodiment, wherein during the synthesis, 10% of the Ni was replaced by manganese (Mn).
Nickel(II) chloride hexahydrate (8.528 g) and iron(II) chloride tetrahydrate (2.744 g) were dissolved in water (18.2 M Ω, 89 ml each). Manganese(II) chloride tetrahydrate (1.092 g) was dissolved in water (18.2 M Ω, 89 ml). The two solutions were mixed.
A reaction flask was placed under nitrogen, and sodium borohydride (10.44 mg) was dissolved in water (18.2 M Ω, 533 ml) therein. The nickel/iron/manganese solution was added dropwise within 10 minutes. Thereafter, the reaction solution was stirred for 30 minutes. The reaction product was then separated, washed with water and ethanol and dried for 12 h at 50° C. The final weight was 4.6 g.

### 17th Exemplary Embodiment OER Catalyst—Manufacture (AB17)

The manufacture took place according to the 13th exemplary embodiment, wherein during the synthesis the ratio of Ni and iron (Fe) was varied.
Nickel(II) chloride hexahydrate (11.694 g) was dissolved in water (18.2 M Ω, 133 ml), and similarly iron(II) chloride tetrahydrate (1.133 g) was dissolved in water (18.2 M Ω, 133 ml). The two solutions were mixed.
A reaction flask was placed under nitrogen, and sodium borohydride (10.44 mg) was dissolved in water (18.2 M Ω, 533 ml) therein. This solution was heated to 50° C. and the nickel/iron solution was added dropwise within 10 minutes. Thereafter, the reaction solution was stirred for 30 minutes. The reaction product was then separated, washed with water and ethanol and dried for 12 h at 50° C. The final weight was 4.5 g.

### 18th Exemplary Embodiment OER Catalyst—Manufacture (AB18)

The manufacture took place according to exemplary embodiment 13, wherein during the synthesis the ratio of Ni and Fe was varied.
Nickel(II) chloride hexahydrate (10.72 g) was dissolved in water (18.2 M Ω, 133 ml), and similarly iron(II) chloride tetrahydrate (1.976 g) was dissolved in water (18.2 M Ω, 133 ml). The two solutions were mixed.
A reaction flask was placed under nitrogen, and sodium borohydride (10.44 mg) was dissolved in water (18.2 M Ω, 533 ml) therein. This solution was subjected to UV radiation at a wavelength of 360 nm and the nickel/iron solution was added dropwise within 10 minutes. Thereafter, the reaction solution was stirred for 30 minutes. The reaction product was separated, washed with water and ethanol and dried for 12 h at 50° C. The final weight was 6.2 g.

### 19th Exemplary Embodiment OER Catalyst—Manufacture (AB19)

The manufacture took place according to exemplary embodiment 13, wherein during the synthesis the ratio of Ni and Fe was varied.
Nickel(II) chloride hexahydrate (8.77 g) was dissolved in water (18.2 M Ω, 133 ml), and similarly iron(II) chloride tetrahydrate (3.670 g) was dissolved in water (18.2 M Ω, 133 ml). The two solutions were mixed.
A reaction flask was placed under nitrogen, and sodium borohydride (10.44 mg) was dissolved in water (18.2 M Ω, 533 ml) therein. This solution was exposed to UV radiation at a wavelength of 360 nm and the nickel/iron solution was added dropwise within 10 minutes. Thereafter, the reaction solution was stirred for 30 minutes. The reaction product was separated, washed with water and ethanol and dried for 12 h at 50° C. The final weight was 6.3 g.

### 20th Exemplary Embodiment OER Catalyst—Manufacture (AB20)

The manufacture took place according to exemplary embodiment 13, wherein after the synthesis the product was tempered at 250° C.
Nickel(II) chloride hexahydrate (9.745 mg) was dissolved in water (18.2 M Ω, 133 ml), and similarly iron(II) chloride tetrahydrate (2.823 g) was dissolved in water (18.2 M Ω, 133 ml). The two solutions were mixed.
A reaction flask was placed under nitrogen, and sodium borohydride (10.44 mg) was dissolved in water (18.2 M Ω, 533 ml) therein. This solution was exposed to ultrasound (160 W, 35 kHz) and the nickel/iron solution was added dropwise within 10 minutes. Thereafter, the reaction solution was stirred for 30 minutes. The reaction product was separated, washed with water and ethanol and dried for 12 h at 50° C. Final weight 5.45 g.
200 mg of the reaction product was tempered in a porcelain combustion boat at 250° C. under an air atmosphere for one hour in a tubular furnace.

### 21st Exemplary Embodiment OER Catalyst—Manufacture (AB21)

The manufacture took place according to exemplary embodiment 13, wherein after the synthesis the product was tempered at 300° C.
Nickel(II) chloride hexahydrate (9.745 mg) was dissolved in water (18.2 M Ω, 133 ml), and similarly iron(II) chloride tetrahydrate (2.823 g) was dissolved in water (18.2 M Ω, 133 ml). The two solutions were mixed.
A reaction flask was placed under nitrogen, and sodium borohydride (10.44 mg) was dissolved in water (18.2 M Ω, 533 ml) therein. This solution was exposed to ultrasound (160 W, 35 kHz) and the nickel/iron solution was added dropwise within 10 minutes. Thereafter, the reaction solution was stirred for 30 minutes. The reaction product was separated, washed with water and ethanol and dried for 12 h at 50° C. The final weight was 5.45 g.
200 mg of the reaction product was tempered in a porcelain combustion boat at 300° C. under an air atmosphere for one hour in a tubular furnace.

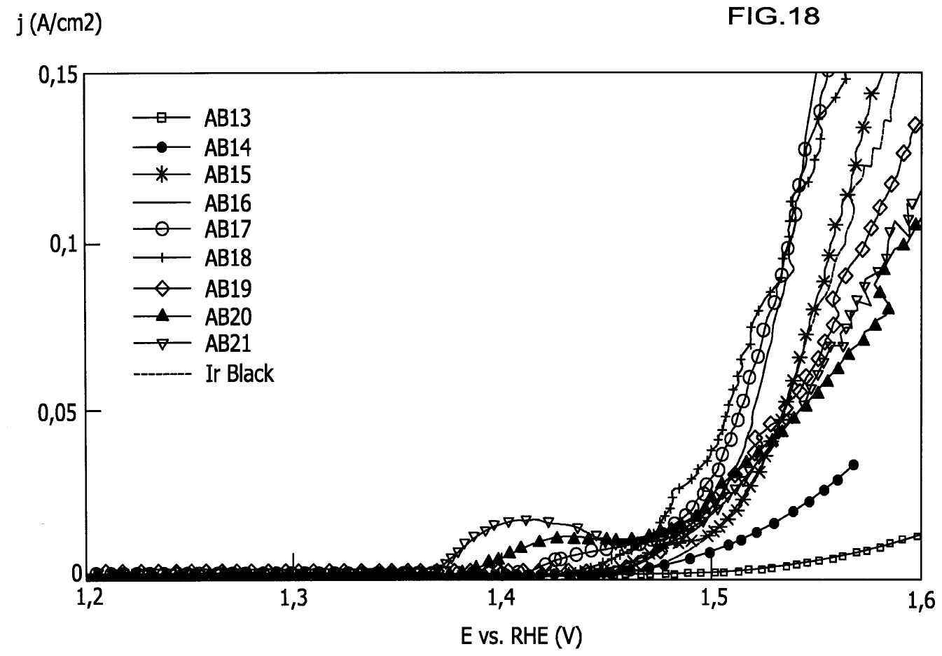

FIG. 18 shows the dependency of the current densities on the respective anode potentials (relative to the reversible hydrogen electrode RHE) of the OER catalysts of the exemplary embodiments 13 to 21. The measurements were each made by means of a rotating disk electrode. The greatest current density at the lowest potential was achieved for the OER catalyst according to the exemplary embodiments 13, 20 and 21. As a reference, the dependency of the current density on the anode potential for iridium black is also plotted.

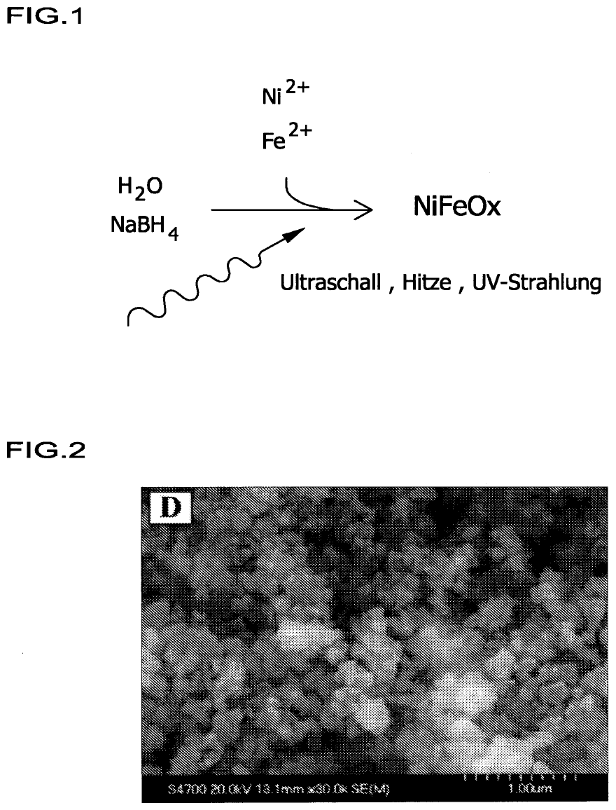

FIG. 1 shows schematically the syntheses described according to the exemplary embodiments above of the electrocatalyst 38 in the form of the OER catalyst 40.

FIG. 2 shows a scanning electron micrograph of the OER catalyst nickel iron oxide (NiFeOₓ). The tested sample is amorphous.

The exemplary embodiments 1 to 4 described are purely exemplary. The synthesis routes described are, in principle, transferrable to the synthesis of oxides, sulfides, carbides and phosphides and a mixture of the metals from the fourth period of the periodic table, in particular zinc, manganese, copper, iron, nickel, chromium and cobalt and the metals from the fifth period of the periodic table, specifically molybdenum and silver.

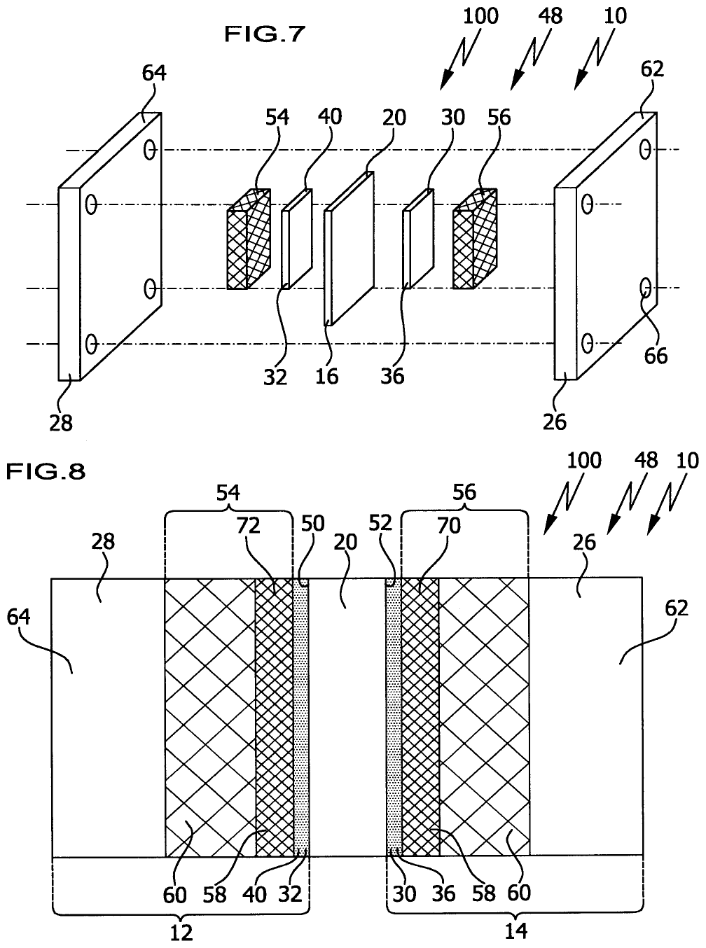

FIGS. 7 and 8 show the schematic construction of an electrolysis cell 48 of a water electrolyzer.

Arranged between a plate-shaped anode 28 and a plate-shaped cathode 26 is an ion exchange membrane 16 in the form of an anion exchange membrane 20. The areal ion exchange membrane 16 has a first membrane side 50 which faces in the direction of the anode 28 and a second membrane side 52 facing in the opposite direction, which faces in the direction of the cathode 26.

The first membrane side is in areal contact with an anodic catalyst layer 32 which contains the OER catalyst 40 or consists thereof. The second membrane side 52 is in areal contact with the cathodic catalyst layer 30 which consists of or contains the HER catalyst 36. Arranged between the anode 28 and the anodic catalyst layer 32 is an anodic gas diffusion layer 54 which is in areal contact on one side with the anode 28 and, on the other side, with the anodic catalyst layer 32.

Arranged between the cathodic catalyst layer 30 and the cathode 26 is a cathodic gas diffusion layer 56 which is in areal contact on one side with the cathodic catalyst layer 30 and on the other side with the anode 26.

The anodic gas diffusion layer 54 and the cathodic gas diffusion layer 54 are schematically divided into two regions 58 and 60 in FIG. 8, wherein the region 60, which is in contact with one of the electrodes 62 or 64 respectively, which are the cathode 26 on one side and the anode 28 on the other side, has a greater porosity than the region 58, which is positioned between the region 60 and the respective catalyst layer 30 or 32.

By means of this configuration of the gas diffusion layers 54 and 56, the reaction gases hydrogen from the cathodic half cell 14 and oxygen from the anodic half cell 12 can be optimally conducted away.

The OER catalyst in the arrangements described in relation to FIGS. 7 and 8 can contain, in particular, nickel iron oxide or iridium. The HER catalyst is or contains molybdenum carbide or platinum on the cathode 26 which is made of stainless steel.

The electrodes 62 and 64 are configured in the form of current collector end plates made of stainless steel.

The regions 58 with lower porosity are configured in the exemplary embodiments in the form of fibre mats, in particular in the form of carbon fibre mats or titanium fibre mats. They have a thickness of approximately 250 μm. If these fibre mats are used, the region 60 is formed from a stainless steel wire weave stack which has a thickness of approximately 4 mm.

The stack represented schematically in FIG. 8 is connected and permanently held together by means of screws which penetrate the bores 66 represented schematically in FIG. 8.

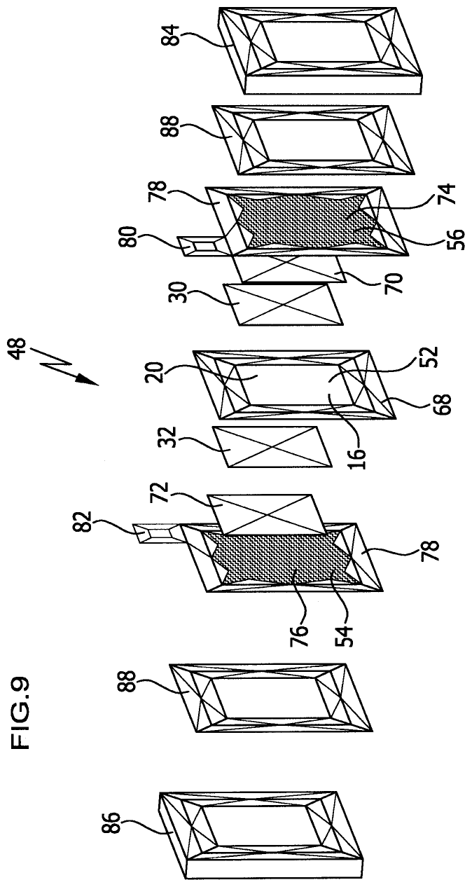

FIG. 9 shows a further exemplary embodiment of a schematic construction of an electrolysis cell 48. Herein also, the reference signs used above are again used in the description of electrolysis cells 48.

The ion exchange membrane 16 is surrounded by a seal 68 and is areally in contact with the membrane sides 52 and 50 on one side with the cathodic catalyst layer 30 and on the other side with the anodic catalyst layer 32. The catalyst layers 30 and 32 are each applied to a substrate 70 and/or 72 which is configured in the form of a fibre mat. Carbon fibre mats and titanium fibre mats can be used herein. The substrates 70 and 72 form the above-described regions 58.

Together with the current collectors 74 and 76 which are formed from the stainless steel wire weave stack, the substrates 70 and 72 together form the cathodic gas diffusion layer 56 and/or the anodic gas diffusion layer 54. The current collectors 74 and 76 are also surrounded by a seal 78. For connecting to a current source, connecting contacts 80 and/or 82 are provided on the current collectors 74 and 76.

The current collectors 74 and 76 are each connected by means of a seal 88 to an end plate 84 and/or 86. The end plates 84 and 86 are screwed together, in a manner not shown, and press together the elements arranged between them.

The regions 58 in the arrangement in FIG. 8 each form a substrate 70 and/or 72 for the cathodic catalyst layer 30 and/or the anodic catalyst layer 32.

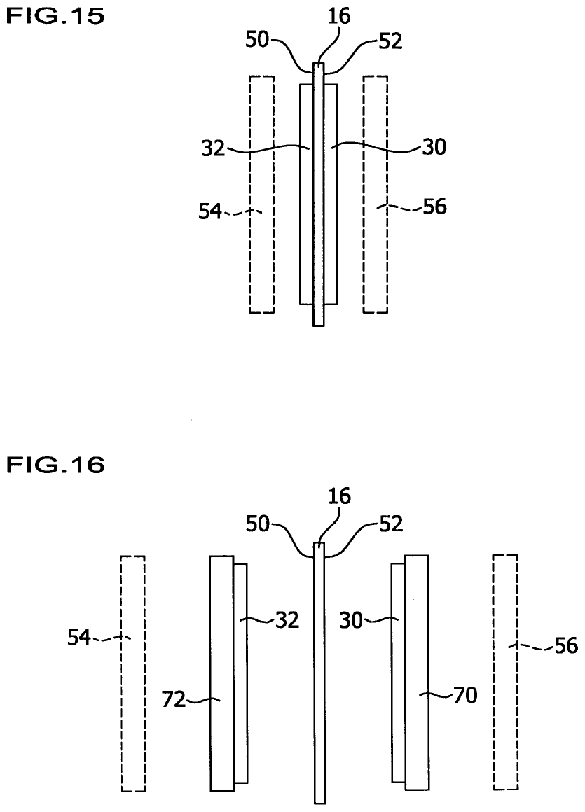

In order to form the electrolysis cells 48, the catalyst layers 30 and 32 can be applied either, as shown schematically in FIG. 15, to the membrane sides 50 and/or 52 of the ion exchange membrane 16. In addition, gas diffusion layers 56 and/or 54 are applied in the form of stainless steel wire weave stacks to the catalyst layers 30 and 32.

Alternatively, as is represented schematically in FIG. 16, the catalyst layers 30 and 32 are applied to the substrates 70 and 72. These are configured, as mentioned above, in the form of fibre mats, in particular carbon fibre mats, stainless steel fibre mats, titanium fibre mats or nickel fibre mats.

In the variant according to FIG. 16, due to the thin substrates 70 and 72, a gas diffusion layer 54 and/or 56 in the form of a stainless steel wire weave stack is additionally placed on the sides of the substrate 70 and 72 facing away from the catalyst layers 30 and 32, in order to enable an optimal transport of the electrolysis gases.

Further, mixed forms of the variants according to FIGS. 15 and 16 are also possible. For example, the anodic catalyst layer 32 as represented in FIG. 15 can be applied to the ion exchange membrane 16, while the cathodic catalyst layer, by contrast, can be applied to the substrate 70 or vice versa, the cathodic catalyst layer can be applied to the second membrane side 52 and the anodic catalyst layer 32 to the substrate 72.

The catalyst layers 30 and 32 optionally also contain ionomer from which the ion exchange membrane 16 is formed. Thus, in particular, an optimal connection of the catalyst layers 30 and 32 to the ion exchange membrane 16 can be created and at the same time a high ion conductivity in the catalyst layer can be ensured, specifically also when the catalyst layers 30 and 32 are initially applied to substrates 70 and 72, as represented schematically in FIG. 16, and are then brought areally into contact with the uncoated ion exchange membrane 16 and pressed.

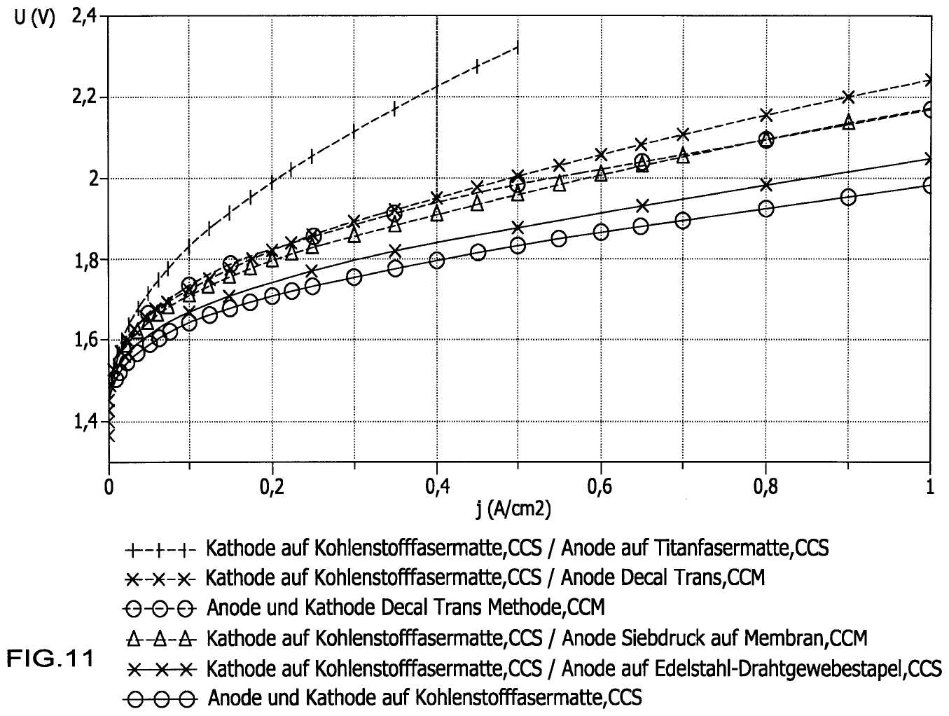

FIG. 11 shows, by way of example, the result of cell tests, wherein an aqueous 0.1 M potassium hydroxide solution was used as the electrolyte in each case. The indication “CCS” means that the respective catalyst layer 30 and/or 32 was applied to a substrate 70 and/or 72. The indication “CCM” means that the catalyst layer 30 and/or 32 was applied directly to the ion exchange membrane 16 or was transferred from a transfer carrier. The cell was either immersed directly, in an open construction, into the electrolyte (open cell) or alternatively, in a closed construction of the cell (closed cell), the electrolyte was pumped from two separated tempered reservoirs through the anode side and the cathode side of the cell, specifically at approximately 10 to 100 ml/min. In the closed cell, the quantity of the gases evolved was also able to be determined.

In FIG. 11 it is clearly apparent that the best cell properties can be achieved if, as the substrates 70 and 72, carbon fibre materials are utilised, onto which the catalyst layers 30 and/or 32 are applied.

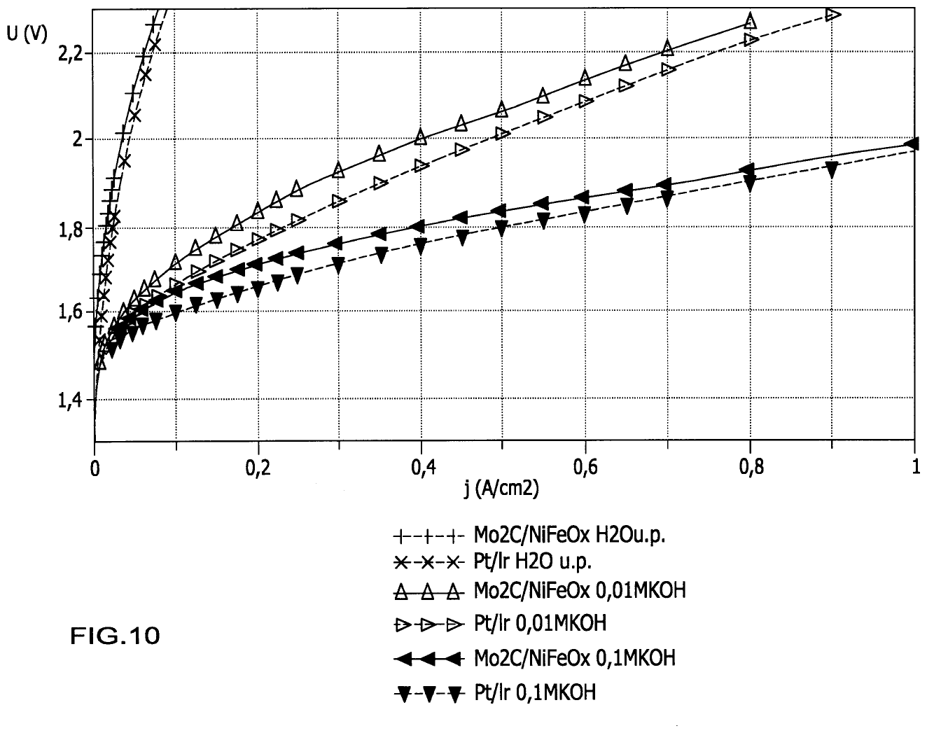

From FIG. 10, it is also evident, in the case of the open cell, that in particular the tested cell configurations in which the catalyst layers 30 and 32 have been applied to a substrate 70 and/or 72, show good function, whereas the application of the catalyst layers 30 and/or 32 onto the ion exchange membrane 16 produces poorer results. What is notable here is the deviation for substrates 70 and 72 in the form of titanium fibre mats with which despite the coating thereof and not of the ion exchange membrane 16, poorer results were obtained.

FIG. 10 shows, by way of example, the results of further cell tests with open cells with the catalysts given in FIG. 10. If 0.1 molar potassium hydroxide solution is used as the electrolyte, the results are best when platinum is used as the HER catalyst and iridium as the OER catalyst. Only insignificantly poorer are the catalysts molybdenum carbide (HER catalyst) and nickel iron oxide (OER catalyst) described above.

Also, with an electrolyte in the form of a 0.01 molar potassium hydroxide solution, nearly comparable values are achieved with the catalysts molybdenum carbide and nickel iron oxide synthesised as described above as when platinum and iridium are used as catalysts.

When pure water is used as the electrolyte, the tested electrolysis cells 48 exhibit relatively poor results regardless of the catalysts used.

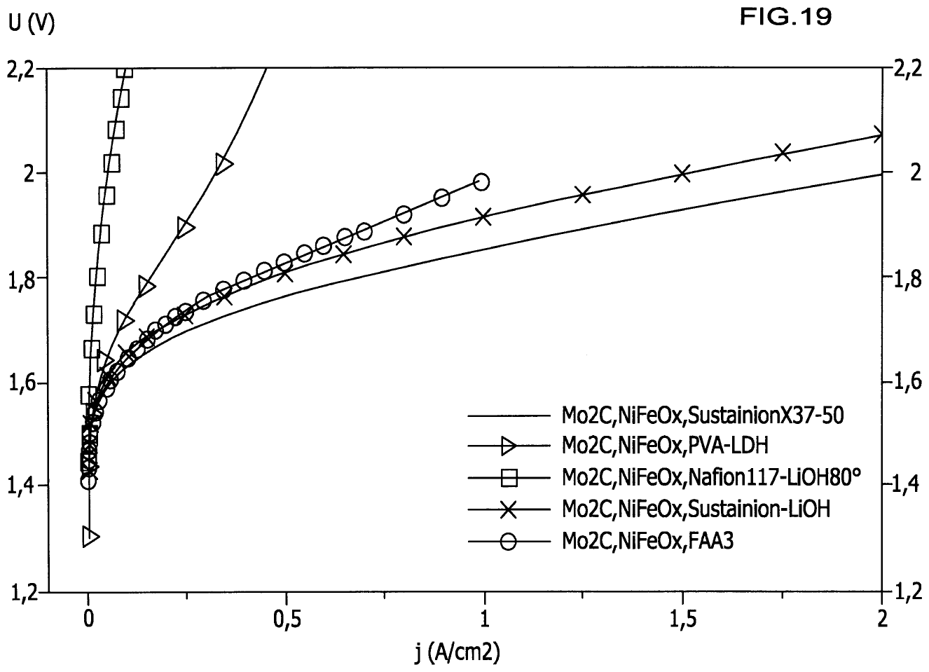

In the open cell with the same use of anodes and cathodes (CCS) with molybdenum carbide and nickel iron oxide, different membranes were used (FIG. 19). Therein, commercial Sustainion X37-50 Grade 60 has the highest performance. The following were also tested: commercial Fumatech FAA-3-30, lithium-modified Sustainion X37-50 (activation of a Sustainion membrane in 1 M LiOH rather than activation in 1 M KOH, subsequent measurement in 0.1 M LiOH rather than 0.1 M KOH), lithium-modified Nafion 117 membrane (activated for 2 h in 10% LiOH at 50° C., subsequent measurement in 0.1 M LiOH rather than 0.1 M KOH and at 80° C. rather than the normal 50° C.), and a self-made PVA-LDH membrane. FIG. 19 shows the dependency of the cell potential on the current density.

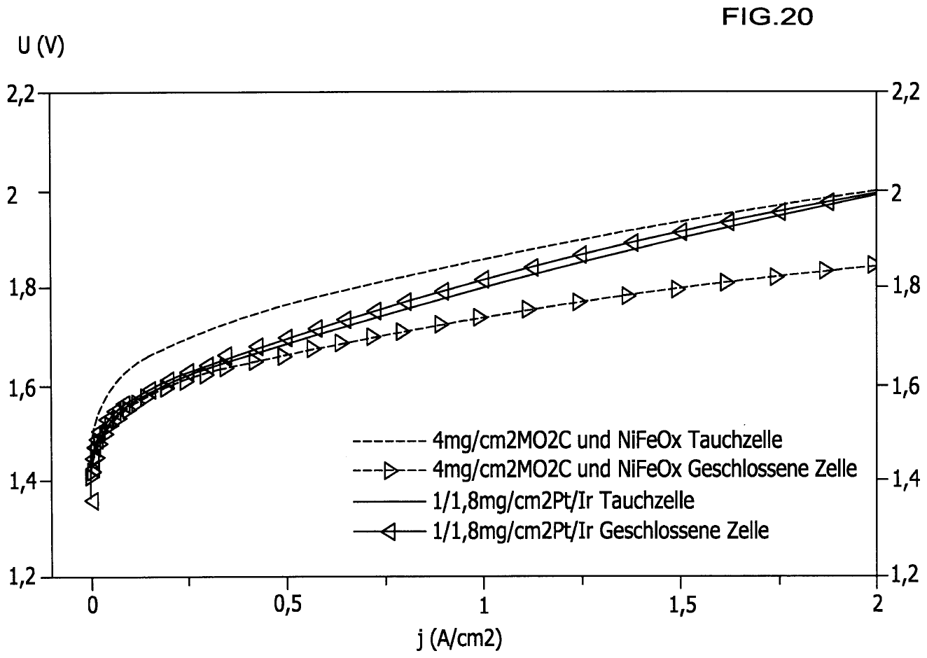

In the closed cell, on use of catalysts without elements from the platinum group when the same components are used as in the open cell at 1.85 V, an improved output of the electrolysis by approximately 150 mV at 2 A/cm² was ascertained. FIG. 20 shows the comparison between an open and a closed cell in the use of nickel iron oxide/molybdenum carbide and iridium/platinum coated substrates (CCS) and Sustainion membrane in 0.1 M KOH and 50° C.

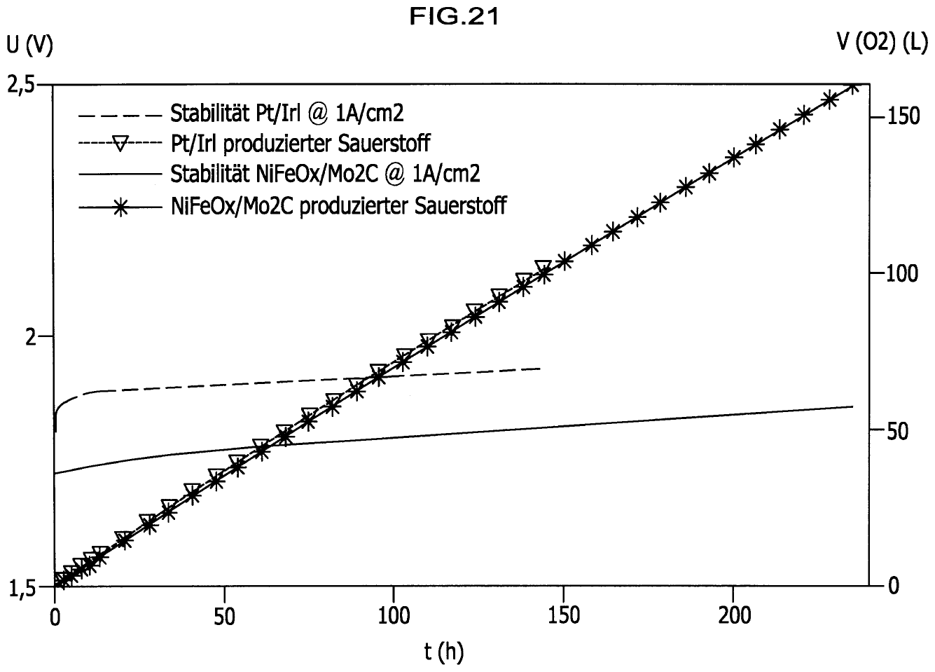

The stability was also investigated in the closed cell (FIG. 21). With these long-term cell tests, over a period from 150 hours to 230 hours continuously at 1 A/cm² current density, water was decomposed and the cell potential required and the oxygen evolved thereby were measured. The efficiency of the electrolysis (calculated from the quantity of oxygen obtained relative to the quantity of oxygen expected from a reaction with 100% Faraday efficiency) was 72% for molybdenum carbide and nickel iron oxide. The degradation after 200 hours was 0.4 mV/h.

Membranes were manufactured in accordance with the following exemplary embodiment.

### 22nd Exemplary Embodiment Membrane-Manufacture (AB22)

For the manufacture of a 50 um PVA-LDH membrane, 517 mg LDH (see below for synthesis) was suspended in 4.5 g ethanol for 1 h under ultrasound. 36.5 g PVA solution in water (5% by weight) was added and the solution was stirred for 1.5 h at 40° C. 1.04 g of a 25% glutaraldehyde solution in water was added dropwise to this solution as a cross-linking reagent and additionally 20 drops of 1 M NaOH solution were added as a catalyst. The solution was stirred for 1 h at 40° C. and then left to rest for 2 h. 5.9 g of the above solution was placed in a 9 cm diameter borosilicate Petri dish and dried, covered, in an oven at 60° C.
LDH (“layered double hydroxide”) for manufacturing the PVA-LDH membrane was synthesised as follows.
Magnesium nitrate hexahydrate (7.62 g) and aluminium nitrate nonahydrate (3.72 g) were dissolved in 160 ml water. A sodium carbonate solution (17.16 g in 540 ml water) was added dropwise thereto within 30 minutes under vigorous agitation. During the addition, the pH value was maintained at 11 by the addition of 1 M NaOH solution. The reaction solution was then stirred for 6 h at 60° C. The precipitate was separated, washed with water and ethanol, suspended in ethanol and dried in an oven at 55° C. The final weight was 3.13 g.
For the formation of the catalyst layers 30 and 32, as described in relation to FIGS. 15 and 16, catalyst solutions in the form of so-called inks are manufactured, which can be applied with different application methods as described below either onto the substrate 70 and/or 72 or onto the membrane sides 52 and/or 54 of the ion exchange membrane 16.

The 23rd and 24th exemplary embodiments described below for manufacturing a catalyst solution served for the electrochemical characterisation by means of a reference electrode.

23rd exemplary embodiment Catalyst solution-manufacture
5 mg Mo₂C or NiFeOₓ was mixed with 1474 μl water (18.2 M Ω), 484 μl 2-propanol and 22 μl Nafion D-520 (5% by weight in a mixture of water and 2-propanol) within 15 minutes under ultrasound.

### 24th Exemplary Embodiment Catalyst Solution—Manufacture

4 mg Mo₂C and 2 mg carbon powder (VXC72R) were mixed with 600 μl water (18.2 MΩ), 150 μl ethanol and 64.5 μl Nafion D-520 (5% by weight in a mixture of water and 2-propanol) for 15 minutes under ultrasound.
4 mg NiFeOₓ was mixed with 400 μl water, 413 μl 2-propanol and 10.24 μl Aquivion D98 (6% by weight in water) within 15 minutes under ultrasound.

### 25th Exemplary Embodiment Catalyst Solution-Manufacture

150 mg Mo₂C or NiFeOₓ was mixed with 1500 μl water and 1500 μl 2-propanol, and 530 mg FAA-3 (5% in ethanol) or Sustainion XB-7 (5% in ethanol) was added and mixed within 15 minutes under ultrasound. An area of 4.4×4.4 cm can be coated with this ink.
   26th exemplary embodiment Catalyst solution-manufacture
50 mg NiFeOₓ was mixed with 200 μl water, 175 mg FAA-3 (5% in ethanol) was added and mixed within 15 minutes under ultrasound. An area of 2×2 cm can be coated with this ink.

The catalyst solutions according to the 23rd exemplary embodiment resulted in better measurement values than the catalyst solutions of the 24th exemplary embodiment.

The 25th exemplary embodiment for forming a catalyst solution was used to coat the substrate 70 and/or 72 with the catalyst coatings 30 and/or 32.

For the coating of the ion exchange membrane 16, the catalyst solutions were manufactured according to the 26th exemplary embodiment and cell measurements were performed. It should be noted herein that the catalyst solution according to the 26th exemplary embodiment was used to form the catalyst layer 32 by screen printing.

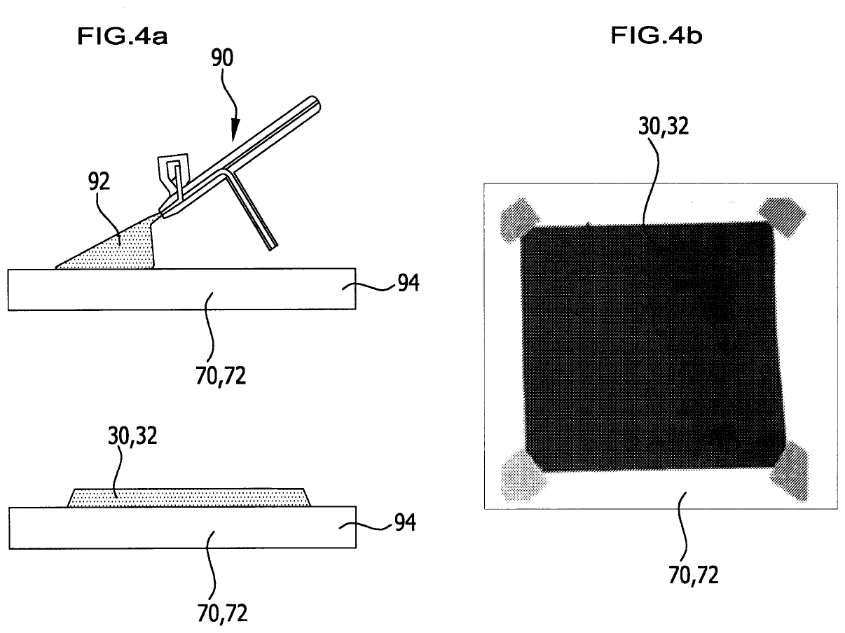

For coating the substrates 70 and 72, the catalyst solution according to the exemplary embodiments 24, 25 and 26 and represented schematically in FIG. 4a was sprayed on with a spray pistol in the form of an airbrush pistol 90 onto the substrate 70 and/or 72. Carbon fibre mats, nickel fibre mats, titanium fibre mats and stainless steel mats served as substrates 70 and/or 72.

The substrates 70 and 72 were heated during spraying with the catalyst solution 92, for example, to 60° C. and the catalyst solution 92 was evenly applied in several layers from a distance of approximately 5 cm by means of an inert gas stream, for example nitrogen, at approximately 2 l/min.

For better adhesion of the catalyst on the substrate 70 and/or 72, in alternative exemplary embodiments, the substrates 70, 72 were pressed on in a hot press at 125° C. for 5 minutes at a pressure of 10 to 50 bar.

FIG. 4b shows the result of a catalyst layer sprayed on in this manner.

In order to coat the ion exchange membrane 16 with one of the catalyst layers 30 and/or 32, the catalyst solution according to the 26th exemplary embodiment is printed with a screen printing machine 96 onto a moist FAA-3-30 membrane conditioned with a 0.1 M KOH solution. The printed area was 2.1×2.1 cm. The screen used for this screen printing is specified by FL-190, 16.7 μm. Following drying of the catalyst layer 30 and/or 32 in air, the ion exchange membrane 16 was placed in a 0.1 M KOH solution.

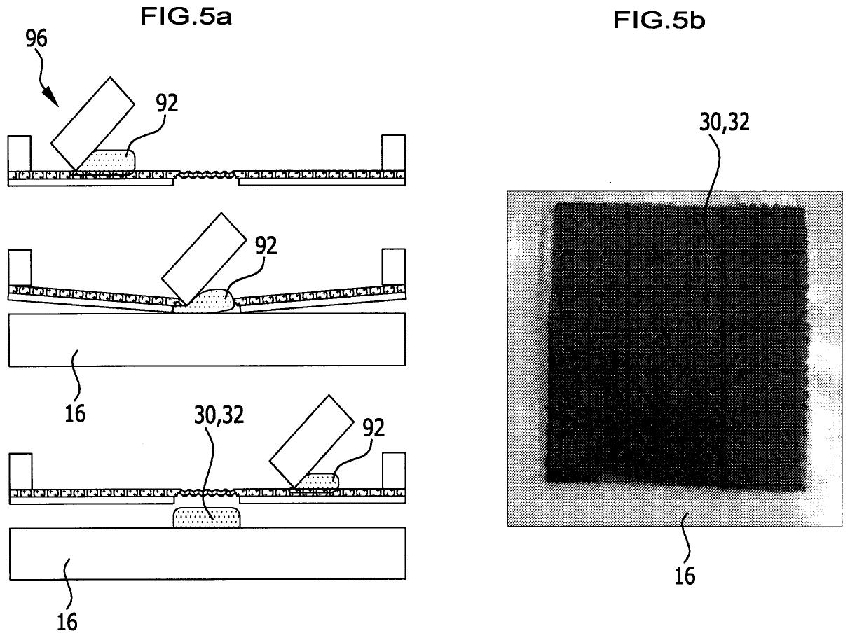

The screen printing of the catalyst solution 92 and/or ink is represented schematically in FIG. 5a. FIG. 5b shows the printed catalyst layer 30 and/or 32.

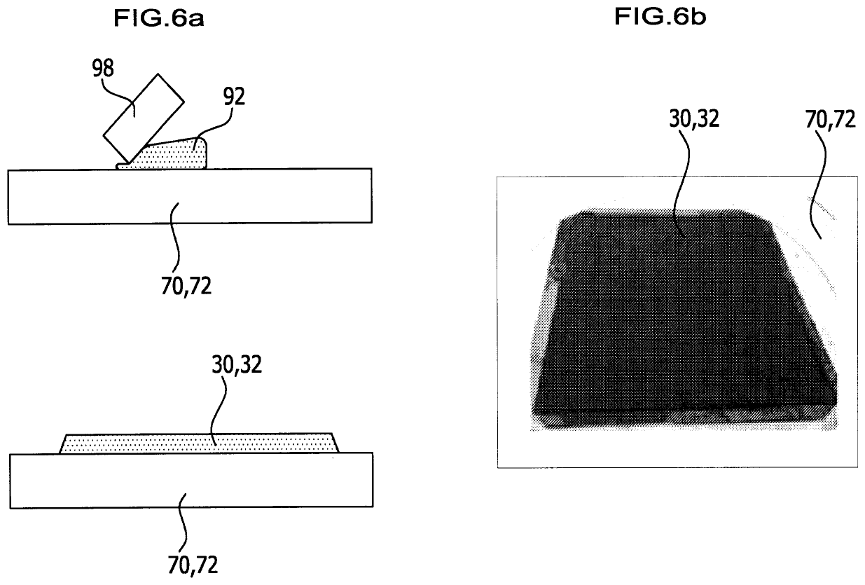

As an alternative method, FIG. 6a shows schematically how the catalyst solution according to the 26th exemplary embodiment is blade coated with a coating blade 98 to form the catalyst layer 30 and/or 32 on a substrate 70 and/or 72.

Rather than the spraying of the catalyst solution 92 according to the 23rd, 24th or 25th exemplary embodiments onto a substrate 70 and/or 72, which is used directly for forming the electrolysis cell 48, a transfer substrate 94 can also be used. In this so-called Decal Trans method also, the catalyst solution 92 is applied with the airbrush pistol 90. The transfer substrate 94 is also heated to approximately 65° C. and the catalyst solution 92 is evenly applied in several layers from a distance of approximately 5 cm by means of a nitrogen stream at approximately 2 l/min. A Teflon film served as the transfer substrate 94.

In order to coat the ion exchange membrane 16 with the catalyst layers 30 and 32, it is placed in a dry state between two transfer substrates 94, each coated on an area of 2.1×2.1 cm. The transfer substrates 94 are coated on one side with an HER catalyst and on the other side with an OER catalyst. These are configured, particularly, in the form of the catalysts molybdenum carbide and nickel iron oxide described above.

The catalyst layers 30 and/or 32 face toward the ion exchange membrane 16 when they are brought together and abut, on the one hand, the first membrane side 50 and, on the other hand, the second membrane side 52. The arrangement of the ion exchange membrane 16 which is arranged between the catalyst layers 30 and/or 32 arranged on the transfer substrates 94 is then placed into a hot press. The catalyst layers 30 and 32 are therein transferred to the ion exchange membrane 16 at a temperature of approximately 65° C. and a pressure of approximately 90 bar within 10 min. Thereafter, the transfer substrates 94 can be pulled off. In this way, the ion exchange membrane 16 is coated on both sides with the catalyst layers 30 and 32.

The exemplary embodiments described for manufacturing electrolysis cells can be combined, as mentioned, with a broad range of catalysts. A substantial advantage of the methods described for forming the catalyst layers 30 and 32 is, in particular, that they can ultimately be applied directly onto substrates 70 and/or 72 as part of the respective electrodes 62 and/or 64. In this way, it is possible to assemble the electrolysis cell merely by clamping the components described. A direct coating of the membrane or a complex transfer of the catalyst layers 30 and/or 32 onto the ion exchange membrane 16 via the Decal Trans method described and a transfer substrate 94 is thereby rendered superfluous.

In addition, the cell tests described above have shown that the coating of the substrates 70 and 72 as part of the electrodes 62 and 64 results in electrolysis cells 48 with better output data than electrolysis cells 48 in which the ion exchange membrane 16 was coated with one or more catalyst layers 30 and/or 32.

The HER catalysts and OER catalysts described, in particular in the form of molybdenum carbide and nickel iron oxide, form excellent alternatives to the expensive noble metals platinum and iridium. They are significantly more economical and almost equally efficient. This enables the manufacture and the economic operation of water electrolyzers 10 on a large scale. This is an important step, particularly with regard to the forthcoming energy revolution and thus the turning away from fossil energy sources to regenerative energy sources.

### REFERENCE SIGNS

10 Water electrolyzer
12 Anodic half cell
14 Cathodic half cell
16 Ion exchange membrane
18 Electrolyte
20 Anion exchange membrane
22 Anion
24 Hydroxide ion
26 Cathode
28 Anode
30 Cathodic catalyst layer
32 Anodic catalyst layer
34 Electrocatalyst
36 HER catalyst
34 Electrocatalyst
40 OER catalyst
42 Current source
44 Positive pole
46 Negative pole
48 Electrolysis cell
50 First membrane side
52 Second membrane side
54 Anodic gas diffusion layer
56 Cathodic gas diffusion layer
58 Region
58 Region
62 Electrode
62 Electrode
66 Bore
68 Seal
70 Substrate
70 Substrate
74 Current collector
74 Current collector
68 Seal
80 Connection contact
80 Connection contact
84 End plate
84 End plate
68 Seal
90 Airbrush pistol
92 Catalyst solution
94 Transfer substrate
96 Screen printing machine
98 Coating blade
100 Electrochemical reactor

1. A method for manufacturing an electrocatalyst in the form of an HER catalyst for a water electrolyzer, wherein the HER catalyst is synthesised from an aqueous solution of a molybdenum salt with the addition of an aromatic amine and an acid.

2. The method according to claim 1, wherein ammonium heptamolybdate is used as the molybdenum salt, wherein aniline is used as the aromatic amine and wherein hydrochloric acid is used as the acid.

3. The method according to claim 1, wherein the synthesised HER catalyst is washed and dried.

4. The method according to claim 3, wherein the dried HER catalyst is baked, in particular at a temperature in a range from approximately 600° C. to approximately 800° C., more particularly at approximately 725° C.

5. A method for manufacturing an electrocatalyst in the form of an OER catalyst for a water electrolyzer, wherein the OER catalyst is synthesised from an aqueous sodium borohydride solution by adding a mixture of an aqueous solution of a nickel salt and an aqueous solution of an iron salt.

6. The method according to claim 5, wherein nickel(II) chloride is used as the nickel salt and wherein iron(II) chloride is used as the iron salt.

7. The method according to claim 5, wherein the aqueous sodium borohydride solution is exposed to ultrasound, heat and/or UV radiation when the mixture is added.

8. The method according to claim 5, wherein a protective gas is applied to the aqueous sodium borohydride solution when the mixture is added.

9. The method according to claim 5, wherein the synthesised OER catalyst is separated, washed and dried.

10. An electrocatalyst in the form of an HER catalyst for a water electrolyzer, wherein the HER catalyst contains at least one chemical compound which is formed of a first transition metal and at least one of the elements carbon, oxygen, sulfur and phosphorus and wherein the first transition metal is molybdenum or tungsten, wherein, in particular, the chemical compound is molybdenum carbide (MoCₓ), molybdenum oxide (MoOₓ) or molybdenum sulfide (MoSₓ).

11. The electrocatalyst according to claim 10, wherein the chemical compound contains at least one second transition metal, wherein the first transition metal and the at least one second transition metal differ from one another, wherein the first transition metal defines a first metallic content of the chemical compound, wherein the at least one second transition metal defines a second metallic content and wherein the first metallic content is greater than the second metallic content.

12. The electrocatalyst according to claim 11, wherein the at least one second transition metal is molybdenum, tungsten, nickel, iron, cobalt, copper or titanium.

13. The electrocatalyst according to claim 11, wherein the chemical compound is W_{2y}MO_{2(1-y)}C, Ni_{2y}MO_{2(1-y)}C or Fe_{y}Mo_{1-y}O₃,
wherein, in particular, the value of y is not more than approximately 0.25.

14. The electrocatalyst according to claim 11, wherein a total metallic content of the chemical compound is 100 Mol % and is defined as the sum of the first metallic content in Mol % and the second metallic content in Mol % and wherein the second metallic content has a value in a range from 0 to approximately 25 Mol % .

15. The electrocatalyst according to claim 10, wherein a content of the chemical compound in the HER catalyst is in a range from approximately 67 percent by weight to approximately 85 percent by weight, in particular approximately 76 percent by weight.

16. The electrocatalyst according to claim 10, wherein the HER catalyst contains a molybdenum oxide, in particular with a content in a range from approximately 5 percent by weight to approximately 13 percent by weight, in particular approximately 9 percent by weight.

17. The electrocatalyst according to claim 10, wherein the HER catalyst contains molybdenum, in particular with a content in a range from approximately 10 percent by weight to approximately 20 percent by weight, in particular approximately 15 percent by weight.

18. The electrocatalyst according to claim 10, wherein the HER catalyst has a needle-shaped, or substantially needle-shaped, structure.

19. The electrocatalyst according to claim 10, wherein the HER catalyst is manufactured by a method according to one of the claims I to 4 claim 1.

20. An electrocatalyst in the form of an OER catalyst for a water electrolyzer, wherein the OER catalyst contains nickel and iron in combination with oxygen and/or phosphorus, wherein a nickel content of the nickel in the OER catalyst is greater than an iron content of the iron in the OER catalyst and wherein a value of the sum of the nickel content and of the iron content is at least approximately 50 Mol % of a total metallic content of the OER catalyst.

21. The electrocatalyst according to claim 20, wherein the OER catalyst contains cobalt, copper and/or manganese and wherein the sum of a cobalt content, a copper content and a manganese content in the OER catalyst has a value that is smaller than the iron content.

22. The electrocatalyst according to claim 21, wherein the sum of the cobalt content, the copper content and the manganese content in the total metallic content has a value in a range from 0 to approximately 20 Mol %.

23. The electrocatalyst according to claim 20, wherein the electrocatalyst is NixFeyCuzO4 or NiₓFe_{y}Mn_{z}O₄ and wherein x>y>z.

24. The electrocatalyst according to claim 20, wherein the OER catalyst contains nickel, iron and oxygen, wherein a content of nickel lies in a range from approximately 40 percent by weight to approximately 85 percent by weight, wherein a content of iron lies in a range from approximately 1 percent by weight to approximately 30 percent by weight and wherein a content of oxygen lies in a range from approximately 10 percent by weight to approximately 35 percent by weight.

25. The electrocatalyst according to claim 16, wherein the OER catalyst has a structure in the form of relatively large clusters that are covered with small nanoparticles.

26. The electrocatalyst according to claim 16, wherein the OER catalyst is manufactured by a method according to claim 1.

27. A electrode for an electrochemical cell, wherein applied to the electrode is a catalytically active catalyst layer which contains an electrocatalyst or is formed by an electrocatalyst, wherein the electrocatalyst is an electrocatalyst in the form of an HER catalyst for a water electrolyzer, wherein the HER catalyst contains at least one chemical compound which is formed of a first transition metal and at least one of the elements carbon, oxygen. sulfur and phosphorus and wherein the first transition metal is molybdenum or tungsten.

28. The electrode according to claim 27, wherein the electrode comprises a gas diffusion layer and wherein the catalyst layer is applied to the gas diffusion layer.

29. The electrode according to claim 27, wherein the electrode is configured in the form of an anode and wherein the electrocatalyst is an OER catalyst, in particular an OER catalyst according to claim 20.

30. The electrode according to claim 27, wherein the electrode is configured in the form of a cathode and wherein the electrocatalyst is an HER catalyst, in particular an HER catalyst according to claim 10.

31. An ion exchange membrane for an electrochemical reactor, wherein the ion exchange membrane has a first membrane side and a second membrane side, wherein applied to the first and/or the second membrane side is a catalytically active catalyst layer which contains an electrocatalyst or is formed by an electrocatalyst, wherein the electrocatalyst is an electrocatalyst in the form of an HER catalyst for a water electrolyzer, wherein the HER catalyst contains at least one chemical compound which is formed of a first transition metal and at least one of the elements carbon, oxygen, sulfur and phosphorus and wherein the first transition metal is molybdenum or tungsten.

32. The ion exchange membrane according to claim 31, wherein the ion exchange membrane is configured in the form of an anion exchange membrane.

33. The ion exchange membrane according to claim 31, wherein a first catalyst layer is applied to the first membrane side, wherein the first catalyst layer contains a first electrocatalyst or is formed by a first electrocatalyst and wherein the first electrocatalyst is an OER catalyst, in particular an OER catalyst according to claim 20.

34. The ion exchange membrane according to claim 31, wherein a second catalyst layer is applied to the second membrane side, wherein the second catalyst layer contains a second electrocatalyst or is formed by a second electrocatalyst and wherein the second electrocatalyst is an HER catalyst, in particular an HER catalyst according to claim 10.

35. A method for manufacturing an ion exchange membrane for an electrochemical reactor, wherein the ion exchange membrane has a first membrane side and a second membrane side, wherein a catalytically active catalyst layer, which contains an electrocatalyst or is formed by an electrocatalyst, is applied to the first and/or the second membrane side, wherein the electrocatalyst is an electrocatalyst in the form of an HER catalyst for a water electrolyzer, wherein the HER catalyst contains at least one chemical compound which is formed of a first transition metal and at least one of the elements carbon, oxygen, sulfur and phosphorus and wherein the first transition metal is molybdenum or tungsten,

36. The method according to claim 35, wherein, in order to apply the first catalyst layer to the first membrane side and the second catalyst layer to the second membrane side, the first catalyst layer applied to a first transfer carrier is brought into areal contact with the first membrane side (50) and the second catalyst layer applied to a second transfer carrier is brought into areal contact with the second membrane side and they are pressed against one another.

37. The method according to claim 36, wherein the catalyst layers and the ion exchange membrane are heated during the pressing, in particular to a temperature in a range from approximately 40° C. to approximately 130° C., more particularly approximately 65° C.

38. The method according to claim 36, wherein the pressing is carried out with a pressure in a region from approximately 5 bar to approximately 130 bar.

39. The method according to claim 36, wherein the pressing is carried out over a time period in a region from approximately 1 min to approximately 15 min, in particular approximately 4 min.

40. The method according to claim 36, wherein, after the pressing, the transfer carriers are pulled off the catalyst layers.

41. A water electrolyzer having a first electrode, a second electrode and an ion exchange membrane arranged between the first electrode and the second electrode, wherein arranged between the first electrode and the ion exchange membrane is a first catalytically active catalyst layer which contains a first electrocatalyst or is formed by a first electrocatalyst and wherein arranged between the second electrode and the ion exchange membrane is a second catalytically active catalyst layer which contains a second electrocatalyst or is formed by a second electrocatalyst, wherein the first electrocatalyst and/or the second electrocatalyst is an electrocatalyst in the form of an HER catalyst for a water electrolyzer, wherein the HER catalyst contains at least one chemical compound which is formed of a first transition metal and at least one of the elements carbon, oxygen, sulfur and phosphorus and wherein the first transition metal is molybdenum or tungsten.

42. The water electrolyzer according to claim 41, wherein the first electrode and/or the second electrode is configured in the form of an electrode according to claim 27.

43. The water electrolyzer according to claim 41, wherein the first electrode is configured in the form of an anode, wherein the second electrode is configured in the form of a cathode and wherein the ion exchange membrane is configured in the form of an anion exchange membrane.

44. The water electrolyzer according to claim 41, wherein the first electrocatalyst is an OER catalyst and wherein the second electrocatalyst is an HER catalyst.

45. The water electrolyzer according to claim 41, wherein the first catalyst layer is applied to the first electrode or to the ion exchange membrane and wherein the second catalyst layer is applied to the second electrode or to the ion exchange membrane.

46. The water electrolyzer according to claim 45, wherein the first electrode with the first catalyst layer, the ion exchange membrane and the second electrode with the second catalyst layer are pressed against one another.

47. The water electrolyzer according to claim 41, wherein the water electrolyzer contains an electrolyte with a pH value in the range from approximately 7 to approximately 13, in particular in the range from approximately 7 to approximately 11.

48. The water electrolyzer according to claim 47, wherein the electrolyte is formed by a neutral to alkaline salt dissolved in a solvent.

49. The water electrolyzer according to claim 48, wherein the neutral to alkaline salt
a) has a concentration with a value in a range from 0 to approximately 0.4 molar, in particular in a range from 0 to 0.1 molar,
and/or
b) potassium hydroxide (KOH), sodium hydroxide (NaOH), lithium hydroxide (LiOH), sodium or potassium carbonate or sodium or potassium hydrogencarbonate (Na₂CO₃, K₂CO₃, NaHCO₃, KHCO₃).

50. The water electrolyzer according to claim 48, wherein the solvent is or contains water or alcohol.

51. A method for manufacturing a catalytically active catalyst layer which contains an electrocatalyst or is formed by an electrocatalyst for an electrochemical reactor, wherein the catalyst layer is applied to a substrate, wherein an electrocatalyst in the form of an HER catalyst for a water electrolyzer, is used as the electrocatalyst, wherein the HER catalyst contains at least one chemical compound which is formed of a first transition metal and at least one of the elements carbon, oxygen, sulfur and phosphorus and wherein the first transition metal is molybdenum or tungsten.

52. The method according to claim 51, wherein as the substrate there is used an electrode, a gas diffusion layer arranged on an electrode or an ion exchange membrane of the electrochemical reactor or a transfer carrier.

53. The method according to claim 52, wherein as the substrate there is used a carbon fibre mat, a metal fibre mat, in particular a titanium fibre mat, a nickel fibre mat or a stainless steel fibre mat or a stainless steel wire weave stack.

54. The method according to claim 52, wherein the catalyst layer applied to the transfer carrier is applied to the electrode, the gas diffusion layer arranged on an electrode or the ion exchange membrane of the electrochemical reactor and the transfer carrier is pulled off.

55. The method according to claim 51, wherein as the transfer carrier there is used a film, in particular made of plastics, further in particular polytetrafluoroethylene, or metal.

56. The method according to claim 51, wherein the catalyst layer is formed by applying a catalyst solution which contains the electrocatalyst onto the substrate.

57. The method according to claim 56, wherein the substrate is heated during the application of the catalyst solution, in particular to a temperature in a range from approximately 50° C. to approximately 90° C., more particularly to approximately 65° C.

58. The method according to claim 56, wherein the catalyst solution is applied by spraying, screen printing, film spreading or blade coating onto the substrate.

59. The method according to claim 58, wherein the catalyst solution is applied by spraying on a plurality of layers with a spray pistol from a distance from approximately 3 cm to approximately 10 cm, in particular approximately 5 cm by means of an inert gas stream, in particular a nitrogen and/or argon stream with a volume flow in a range from approximately 1 l/min to approximately 5 l/min, in particular 2 l/min.

60. The method according to claim 56, wherein the catalyst solution applied to the substrate is dried.

61. The method according to claim 56, wherein the catalyst solution is formed by dissolving the electrocatalyst in a solvent, in particular, water and/or alcohol.

62. The method according to claim 61, wherein propanol, in particular 2-propanol is used as the alcohol.

63. The method according to claim 61, wherein an ion exchanger ionomer is added to the solution of the electrocatalyst in the solvent.

64. The method according to claim 63, wherein Nafion, Aquivion, Sustainion XB-7 and/or Fumion is used as the ion exchange ionomer.

65. The method according to claim 56, wherein the catalyst solution is mixed before the application onto the substrate under the action of ultrasound, in particular during a mixing time in a region from approximately 5 min to approximately 25 min, further in particular approximately 15 min.

66. A method for manufacturing a water electrolyzer having a first electrode, a second electrode and an ion exchange membrane arranged between the first electrode and the second electrode, wherein arranged between the first electrode and the ion exchange membrane is a first catalytically active catalyst layer which contains a first electrocatalyst or is formed by a first electrocatalyst and wherein arranged between the second electrode and the ion exchange membrane is a second catalytically active catalyst layer which contains a second electrocatalyst or is formed by a second electrocatalyst, wherein the first catalyst layer is applied to the first electrode and/or the second catalyst layer is applied to the second electrode and wherein the first electrode and the second electrode are pressed against the ion exchange membrane arranged between them.

67. The method according to claim 66, wherein an electrocatalyst according to claim 10 is used as the first electrocatalyst and/or as the second electrocatalyst.

68. The method according to claim 67, wherein electrodes according to claim 27 are used as the first electrode and as the second electrode.

69. The method according to claim 66, wherein the first catalyst layer and/or the second catalyst layer is formed by a method according to claim 51.
